(19) United States
(12) Patent Application Publication
(10) Pub. No.: US 2021/0256863 A1
(43) Pub. Date: Aug. 19, 2021

(54) INFORMATION PROCESSING SYSTEM, INFORMATION PROCESSING APPARATUS, AND INFORMATION PROCESSING METHOD

(71) Applicant: Mitsuo ANDO, Fukuoka (JP)

(72) Inventor: Mitsuo ANDO, Fukuoka (JP)

(21) Appl. No.: 17/140,191

(22) Filed: Jan. 4, 2021

(30) Foreign Application Priority Data
Feb. 13, 2020 (JP) 2020-022677
Apr. 16, 2020 (JP) 2020-073673

(51) Int. Cl. G09B 7/06; G06K 7/14; G09B 5/02

(52) U.S. Cl. CPC G09B 7/06; G06K 7/1434; G09B 5/02; G06K 7/1417

(57) ABSTRACT

An information processing system includes: an information processing apparatus; a first terminal apparatus to request generation of a code including identification information for identifying a service provided by the information processing apparatus; and a second terminal apparatus to scan the code. The information processing apparatus includes circuitry to set, based on information received from the first terminal apparatus, information indicating a first input item to be displayed on the first terminal apparatus in association with the service, and set, based on information received from the first terminal apparatus, information indicating a second input item that is different from the first input item and that is to be displayed on the second terminal apparatus, in association with the service, prior to the generation of the code.

### CROSS-REFERENCE TO RELATED APPLICATIONS

This patent application is based on and claims priority pursuant to 35 U.S.C. §119(a) to Japanese Patent Application No. 2020-022677, filed on Feb. 13, 2020 and Japanese Patent Application No. 2020-073673, filed on Apr. 16, 2020, in the Japan Patent Office, the entire disclosure of which is hereby incorporated by reference herein.

### BACKGROUND

### Technical Field

The present disclosure relates to an information processing system, an information processing apparatus, and an information processing method.

### Description of the Related Art

Recently, various services using codes including two-dimensional codes such as QR codes (registered trademark) have been spreading. One example of such services is a service for storing image data of an image captured by a terminal apparatus after the terminal apparatus scanning a QR code (registered trademark), in a storage destination indicated by the QR Code.

According to the above-described technique of the related art, information that is included in the QR code and indicates the storage destination is determined in advance in a fixed manner for the service. That is, according to the above-described technique of the related art, in a service utilized via a code such as a QR code, a provider of the service determines in advance information associated with the service such as information indicating the storage destination of data. Therefore, a user is not permitted to flexibly set such information in accordance with the situation in which the user uses the service among services that generate codes such as QR codes and that are made available in response to the user scanning the generated codes.

### SUMMARY

Example embodiments include an information processing system including: an information processing apparatus; a first terminal apparatus to request generation of a code including identification information for identifying a service provided by the information processing apparatus; and a second terminal apparatus to scan the code. The information processing apparatus includes circuitry to set, based on information received from the first terminal apparatus, information indicating a first input item to be displayed on the first terminal apparatus in association with the service, and set, based on information received from the first terminal apparatus, information indicating a second input item that is different from the first input item and that is to be displayed on the second terminal apparatus, in association with the service, prior to the generation of the code.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a configuration of an information processing system according to a first embodiment;

FIG. 2 is a diagram illustrating an example of a situation in which the information processing system according to the first embodiment is used;

FIG. 3 is a block diagram illustrating an example of a hardware configuration of a server apparatus;

FIG. 4 is a block diagram illustrating an example of a hardware configuration of a terminal apparatus;

FIG. 5 is a block diagram illustrating an example of functional configurations of the server apparatus and the terminal apparatuses according to the first embodiment;

FIG. 6 is a diagram illustrating an example of a registration information storage unit according to the first embodiment;

FIG. 7 is a diagram illustrating an example of an app information storage unit according to the first embodiment;

FIG. 8 is a diagram illustrating an example of a user information storage unit according to the first embodiment;

FIG. 9 is a diagram illustrating an example of a submission information storage unit according to the first embodiment;

FIG. 10 is a diagram illustrating an example of a questionnaire information storage unit according to the first embodiment;

FIG. 11 is a diagram illustrating an example of a submission material information storage unit according to the first embodiment;

FIG. 12 is a diagram illustrating information stored in a storage unit of a teacher's terminal according to the first embodiment;

FIG. 13 is a diagram illustrating information stored in a storage unit of a student's terminal according to the first embodiment;

FIG. 14 is a first sequence diagram illustrating an operation of the information processing system according to the first embodiment;

FIG. 15 is a first diagram illustrating transition of a screen on the teacher's terminal according to the first embodiment;

FIGS. 16A and 16B (FIG. 16) are a second diagram describing transition of the screen on the teacher's terminal according to the first embodiment;

FIGS. 17A and 17B (FIG. 17) are a third diagram illustrating transition of the screen on the teacher's terminal according to the first embodiment;

FIG. 18 is a second sequence diagram illustrating an operation of the information processing system according to the first embodiment;

FIG. 19 is a fourth diagram illustrating transition of the screen on the teacher's terminal according to the first embodiment;

FIGS. 20A and 20B (FIG. 20) are a third sequence diagram illustrating an operation of the information processing system according to the first embodiment;

FIG. 21 is a diagram illustrating transition of a screen on the student's terminal according to the first embodiment;

FIG. 22 is a diagram illustrating an example of a situation in which an information processing system according to a second embodiment is used;

FIG. 23 is a block diagram illustrating an example of functional configurations of a server apparatus and terminal apparatuses according to the second embodiment;

FIG. 24 is a diagram illustrating an example of a registration information storage unit according to the second embodiment;

FIG. 25 is a diagram illustrating an example of an app information storage unit according to the second embodiment;

FIG. 26 is a diagram illustrating an example of a user information storage unit according to the second embodiment;

FIG. 27 is a diagram illustrating an example of a submission information storage unit according to the second embodiment;

FIG. 28 is a diagram illustrating an example of a transfer destination information storage unit according to the second embodiment;

FIGS. 29A and 29B (FIG. 29) are a sequence diagram illustrating an operation of the information processing system according to the second embodiment; and

FIG. 30 is a diagram illustrating transition of a screen on a student's terminal according to the second embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

### First Embodiment

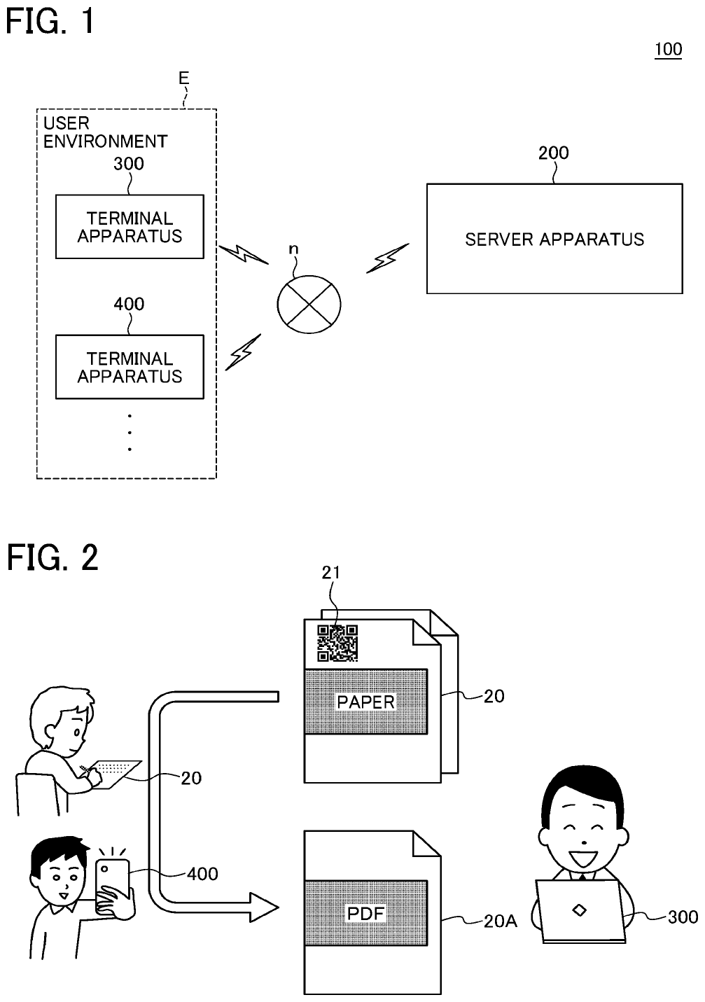

A first embodiment will be described below with reference to the accompanying drawings. FIG. 1 is a diagram illustrating an example of a configuration of an information processing system according to the first embodiment.

An information processing system 100 according to the present embodiment includes a server apparatus 200 and a user environment E. The server apparatus 200 and the user environment E are able to communicate with each other via a wide area network n such as the Internet. Alternatively, the network n may be a network, such as an intranet, that is accessible in a predetermined range.

The user environment E is a system environment at an organization such as a company or at an educational institution such as a school and includes one or more terminal apparatuses 300, 400, . . . , N. In this disclosure, N is any reference number assigned to the terminal apparatus counted last.

The terminal apparatuses 300, 400, . . . , N are information processing terminals carried or used by respective users in the user environment E. For example, smartphones, tablet terminals, personal computers (PCs), mobile phones, or the like may be used as the terminal apparatuses 300, 400, . . . , N.

The terminal apparatuses 300, 400, . . . , N may be connected to the network n (via, for example, a mobile communication network) without via a local area network (LAN) or the like built in the user environment E. The terminal apparatuses 300, 400, . . . , N may be connectable to a network in the user environment E.

In the information processing system 100 according to the present embodiment, the server apparatus 200 allows the terminal apparatus 300 to set information to be associated with a service provided to the user environment E. The server apparatus 200 stores the set information in association with the service. In response to a request from the terminal apparatus 300, the server apparatus 200 generates a code including identification information for identifying the service associated with the set information and causes the terminal apparatus 300 to download the generated code. The code may include the set information.

That is, in the present embodiment, the server apparatus 200 causes, before creating a code including identification information for identifying a service, the terminal apparatus 300 to set information to be associated with the service, and associates, when generating the code, the service and the set information with each other.

Specifically, the information to be associated with the service includes, for example, information indicating an input item for which a value is to be input when a code is generated and information indicating an input item to be displayed in response to scanning of the code.

Examples of the input item for which a value is to be input when a code is generated include an item for setting a storage destination in which data transmitted from a terminal apparatus that has scanned the code is to be stored. Examples of the input item to be displayed in response to scanning of the code include a questionnaire item that is to be displayed on the terminal apparatus that has scanned the code and for which the user inputs the replay.

As described above, in the present embodiment, information to be associated with a service is set before a code that associates the information with the service is generated. Thus, according to the present embodiment, for example, the terminal apparatus 400 that has scanned a code generated in response to a request from the terminal apparatus 300 is successfully caused to perform an operation based on the set information.

The term “code” used in the present embodiment encompasses, for example, a one-dimensional code such as a barcode and a two-dimensional code such as a QR code.

A situation in which the information processing system 100 is used will be described below with reference to FIG. 2. FIG. 2 is a diagram illustrating an example of a situation in which the information processing system according to the first embodiment is used.

Description will be given in FIG. 2 on the assumption that the user environment E is an educational institution or the like, the terminal apparatus 300 is a terminal apparatus used mainly by a teacher, and the terminal apparatus 400 is a terminal apparatus used mainly by a student, for example.

In the following description, the terminal apparatus 300 may also be referred to as the “teacher's terminal 300”, and the terminal apparatus 400 may also be referred to as the “student's terminal 400”.

In addition, in the example illustrated in FIG. 2, a service provided from the information processing system 100 to the user environment E is described as a service that assists collection of submission materials that are submitted by students to a teacher. In the following description, the service that assists collection of submission materials may also be referred to as a “submission service”. The submission materials include, for example, an answer sheet of an examination and a reply to a questionnaire about a lecture.

In the user environment E, the teacher's terminal 300 requests the server apparatus 200 to generate image data of a QR code 21, so that the server apparatus 200 generates image data of the QR code 21. The teacher's terminal 300 then prints distribution materials 20 so that the QR code 21 based on the image data is included in the distribution materials 20.

The QR code 21 is generated so as to include identification information for identifying the submission service. The QR code 21 may include information set in advance by the teacher's terminal 300.

In the present embodiment, the QR code 21 thus generated successfully associates the information set in advance by the teacher's terminal 300 with the submission service.

Examples of the information set in advance by the teacher's terminal 300 include a plurality of different settings such as information indicating a storage destination (submission destination) of a submission material 20A submitted from the student's terminal 400 and input items of a questionnaire to be displayed on the student's terminal 400 in response to the student's terminal 400 scanning the QR code 21.

Note that the term “questionnaire” used in the present embodiment refers to information that associates a question and a reply item (input item) for inputting a reply to the question. In the present embodiment, a questionnaire in which a reply is written for a reply item is referred to as a questionnaire result. That is, a questionnaire result is, in other words, information including a reply to a question included in a questionnaire.

In the present embodiment, information indicating a submission destination of the submission material 20A associated in advance with the submission service and a questionnaire to be displayed on the student's terminal 400 in response to the student's terminal 400 scanning the QR code 21 are identified based on identification information, included in the QR code 21, for identifying the submission service. Consequently, the submission material 20A including the questionnaire result is successfully collected. The QR code 21 may include information indicating the submission destination of the submission material 20A.

In the present embodiment, the submission material 20A includes image data of an image of a filled-in distribution material captured by an image-capturing apparatus of the student's terminal 400 and a questionnaire result of a questionnaire displayed on the student's terminal 400 in response to the student's terminal 400 scanning the QR code 21 printed on the distribution material 20. The filled-in distribution material is a result obtained by a student writing an answer in the distribution material 20 distributed to the student from the teacher.

As described above, according to the present embodiment, a teacher who is a user of the submission service is permitted to set information to be associated with the submission service in accordance with the use situation, for example, the teacher's lecture style. Therefore, according to the present embodiment, the teacher is no longer required to separately distribute a questionnaire about the distribution material. In addition, since the set QR code 21 is given to the distribution material, the submission material is successfully stored in a desired submission destination and the questionnaire of the desired content is successfully collected when required. Consequently, the work of the teacher according to the use situation can be greatly reduced.

According to the present embodiment, it is sufficient that the teacher's terminal 300 merely includes the QR code 21 generated by the server apparatus 200 in document data of the distribution material 20. Thus, the distribution material 20 having the QR code 21 can be easily created.

According to the present embodiment, the submission material 20A including the result obtained by the student writing an answer to the distribution material 20 and the questionnaire result is stored in the submission destination specified by the teacher in advance. Thus, according to the present embodiment, the student is no longer required to hand in the distribution material 20 in which the student has written the answer to the teacher, allowing the student to keep the distribution material 20. In addition, the teacher can save the time for collecting the distribution material that has been filled in by the student and for returning the filled-in distribution material after marking-up the answer.

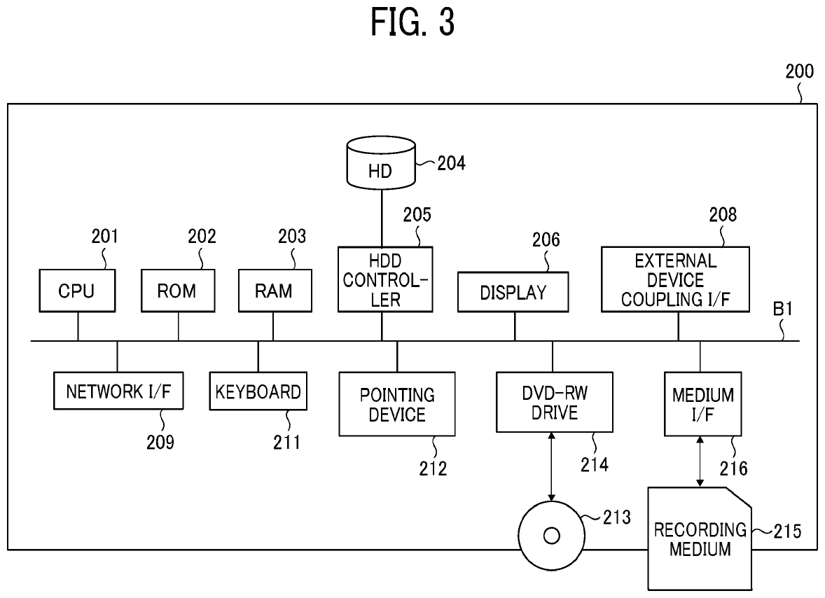

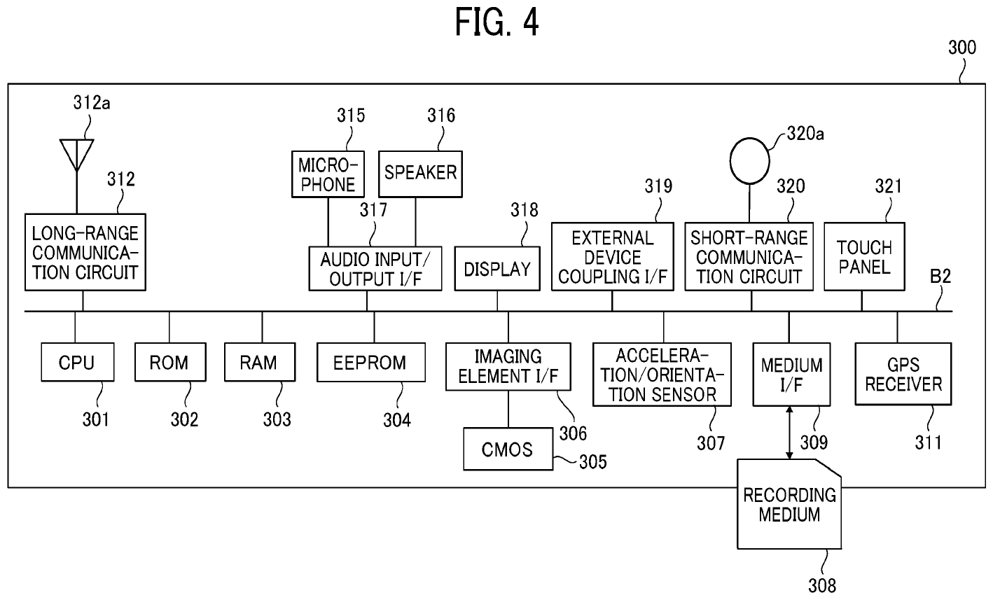

Hardware configurations of the server apparatus and the terminal apparatus of the information processing system 100 according to the present embodiment will be described below with reference to FIGS. 3 and 4. FIG. 3 is a block diagram illustrating an example of the hardware configuration of the server apparatus.

The server apparatus 200 according to the present embodiment is constituted by a computer. As illustrated in FIG. 3, the server apparatus 200 includes a central processing unit (CPU) 201, a read-only memory (ROM) 202, a random access memory (RAM) 203, a hard disk (HD) 204, a hard disk drive (HDD) controller 205, a display 206, an external device coupling interface (I/F) 208, a network I/F 209, a data bus B1, a keyboard 211, a pointing device 212, a digital versatile disc-rewritable (DVD-RW) drive 214, and a medium I/F 216.

The CPU 201 controls the operation of the entire server apparatus 200. The ROM 202 stores a program such as an initial program loader (IPL) used for driving the CPU 201. The RAM 203 is used as a work area for the CPU 201. The HD 204 stores various kinds of data such as a program. The HDD controller 205 controls reading of various kinds of data from or writing of various kinds of data to the HD 204 under control of the CPU 201. The display 206 displays various kinds of information such as a cursor, a menu, a window, characters, or an image. The external device coupling I/F 208 is an interface that couples various external devices to the server apparatus 200. The external devices in this case are, for example, a Universal Serial Bus (USB) memory and a printer. The network I/F 209 is an interface that enables communication of data via the network n. The data bus B1 is, for example, an address bus or a data bus that electrically couples the constituents such as the CPU 201 illustrated in FIG. 3 to one another.

The keyboard 211 is an example of an input device including a plurality of keys that allow a user to input characters, numerals, and various instructions, for example. The pointing device 212 is an example of an input device that allows a user to select or execute various instructions, select a processing target, and move a cursor, for example. The DVD-RW drive 214 controls reading of various kinds of data from or writing of various kinds of data to a DVD-RW 213, which is an example of a removable recording medium. The removable recording medium is not limited to the DVD-RW and may be a digital versatile disc-recordable (DVD-R) or the like. The medium I/F 216 controls reading of data from or writing (storing) of data to a recording medium 215 such as a flash memory.

The server apparatus 200 according to the present embodiment may be, for example, a smartphone, a tablet terminal, a personal digital assistant (PDA), or a wearable PC.

The hardware configuration of the terminal apparatuses 300, 400, . . . , N will be described next with reference to FIG. 4. The hardware configuration of the terminal apparatus 300 will be described herein as an example of the configurations of the terminal apparatuses 300, 400, . . . , N. FIG. 4 is a diagram illustrating an example of the hardware configuration of the terminal apparatus.

The terminal apparatus 300 according to the present embodiment includes a CPU 301, a ROM 302, a RAM 303, an electrically erasable programmable read-only memory (EEPROM) 304, a complementary metal oxide semiconductor (CMOS) sensor 305, an imaging element I/F 306, an acceleration/orientation sensor 307, a medium I/F 309, a global positioning system (GPS) receiver 311.

The CPU 301 is an arithmetic processing unit that controls the operation of the entire terminal apparatus 300. The ROM 302 stores a program such as an IPL used for driving the CPU 301. The RAM 303 is used as a work area for the CPU 301. The EEPROM 304 reads or writes various kinds of data such as a program for a smartphone under control of the CPU 301. Each of the ROM 302, the RAM 303, and the EEPROM 304 is an example of a storage device of the terminal apparatus 300.

The CMOS sensor 305 is an example of a built-in imaging element that images a subject (mainly, a self-portrait) to obtain image data under control of the CPU 301. In alternative to the CMOS sensor, an imaging element such as a charge coupled device (CCD) sensor may be used.

The imaging element I/F 306 is a circuit that controls driving of the CMOS sensor 305. The acceleration/orientation sensor 307 may be any of various sensors such as an electromagnetic compass that detects geomagnetism, a gyrocompass, and an acceleration sensor. The medium I/F 309 controls reading of data from or writing of data to a recording medium 308 such as a flash memory. The GPS receiver 311 receives a GPS signal from a GPS satellite.

The terminal apparatus 300 also includes a long-range communication circuit 312, an antenna 312a for the long-range communication circuit 312, a microphone 315, a speaker 316, an audio input/output I/F 317, a display 318, an external device coupling I/F 319, a short-range communication circuit 320, an antenna 320a for the short-range communication circuit 320, and a touch panel 321.

The long-range communication circuit 312 is a circuit that communicates with another device via a communication network. The microphone 315 is a built-in circuit that converts sound into an electric signal. The speaker 316 is a built-in circuit that converts an electric signal into physical vibration to generate sound of music, voice, or the like. The audio input/output I/F 317 is a circuit that processes input/output of a sound signal from and to the microphone 315 and the speaker 316 under control of the CPU 301.

The display 318 is an example of a display device such as a liquid crystal or organic electro luminescence (EL) display that displays an image of a subject, various icons, and so on. The external device coupling I/F 319 is an interface that couples various external devices to the terminal apparatus 300. The short-range communication circuit 320 is a communication circuit that is compliant with near-field communication (NFC), Bluetooth (registered trademark), or the like. The touch panel 321 is combined with the display 318 to serve as an example of an input device that allows the user to operate the terminal apparatus 300 by touching the display 318. The display 318 is an example of a display device of the terminal apparatus 300.

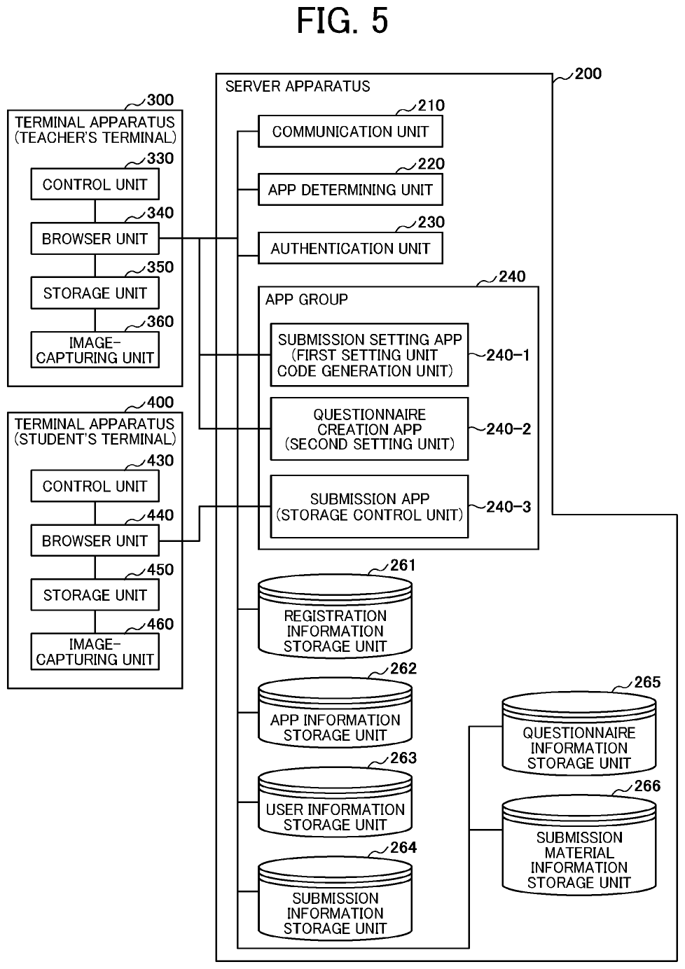

Functions of the server apparatus 200, the terminal apparatus (teacher's terminal) 300, and the terminal apparatus (student's terminal) 400 of the information processing system 100 according to the present embodiment will be described next with reference to FIG. 5. FIG. 5 is a block diagram illustrating an example of functional configurations of the server apparatus and the terminal apparatuses according to the first embodiment.

The teacher's terminal 300 according to the present embodiment includes a control unit 330, a browser unit 340, a storage unit 350, and an image-capturing unit 360, for example. The control unit 330, the browser unit 340, the storage unit 350, and the image-capturing unit 360 are implemented by processes which one or more programs installed on the teacher's terminal 300 cause the CPU 301 to execute. For example, the control unit 330 may be implemented by the operating system or by software such as an application. In the following description, the term “application” may be abbreviated as “app”.

In response to an operation performed by a user of the teacher's terminal 300, the control unit 330 starts the browser unit 340.

The browser unit 340 is, for example, a common web browser and performs a process according to Hypertext Markup Language (HTML) data, a script (for example, JavaScript (registered trademark)), and the like. The browser unit 340 is also started in response to scanning of a code. In response to scanning of a code, the browser unit 340 according to the present embodiment accesses the server apparatus 200 in accordance with an initial access uniform resource locator (URL) included in the code and executes an application corresponding to a registration identifier (ID) included in the code.

The registration ID is identification information for identifying a service and is associated in advance with an application that implements the service. The registration ID according to the present embodiment is an example of identification information for identifying a service. When a single service is implemented by a plurality of applications, a plurality of registration IDs may be associated with the service. The initial access URL indicates a URL to be initially accessed by the teacher's terminal 300 when the teacher's terminal 300 accesses the server apparatus 200 for the first time.

Specifically, in accordance with a redirect request from the server apparatus 200 in response to an access to the initial access URL, the browser unit 340 accesses an application associated with the registration ID among applications of the server apparatus 200. A redirect request is a response from the server apparatus 200 to an access to the initial access URL.

The browser unit 340 acquires, from the application which the browser unit 340 has accessed, data (such as HTML data and a script) indicating a process performing request for the teacher's terminal 300.

In response to an image-capturing instruction from the control unit 330, the image-capturing unit 360 controls an image-capturing apparatus implemented by the CMOS sensor 305 and the imaging element I/F 306 to capture an image.

The student's terminal 400 according to the present embodiment includes a control unit (operating system) 430, a browser unit 440, a storage unit 450, and an image-capturing unit 460, for example. The control unit 430, the browser unit 440, the storage unit 450, and the image-capturing unit 460 are implemented by processes which one or more programs installed on the student's terminal 400 cause the CPU of the student's terminal 400 to execute. Since the functions of the control unit 430, the browser unit 440, the storage unit 450, and the image-capturing unit 460 of the student's terminal 400 are substantially the same as those of the teacher's terminal 300, description thereof is omitted.

The server apparatus 200 according to the present embodiment includes a communication unit 210, an app determining unit 220, an authentication unit 230, and an app group 240. The communication unit 210, the app determining unit 220, the authentication unit 230, and the app group 240 are implemented by processes which one or more programs installed on the server apparatus 200 cause the CPU 201 to execute.

The server apparatus 200 also includes a registration information storage unit 261, an app information storage unit 262, a user information storage unit 263, a submission information storage unit 264, a questionnaire information storage unit 265, and a submission material information storage unit 266. The registration information storage unit 261, the app information storage unit 262, the user information storage unit 263, the submission information storage unit 264, the questionnaire information storage unit 265, and the submission material information storage unit 266 may be implemented by, for example, the ROM 202 or a storage device that is connectable to the server apparatus 200 via a network. Details of the registration information storage unit 261, the app information storage unit 262, the user information storage unit 263, the submission information storage unit 264, the questionnaire information storage unit 265, and the submission material information storage unit 266 will be described later.

The communication unit 210 transmits, to a specified submission destination, a submission material output from the student's terminal 400. The submission material output from the student's terminal 400 includes image data of an image captured by the image-capturing apparatus of the student's terminal 400 and a questionnaire result.

The app determining unit 220 corresponds to the initial access URL. In response to an access to the initial access URL, the app determining unit 220 determines, with reference to the registration information storage unit 261, an application corresponding to the registration ID given to the initial access URL.

In response to determining the application corresponding to the registration ID, the app determining unit 220 transmits, to the entity that is accessing the initial access URL, a response including a redirect request including a URL of this application.

In the present embodiment, for the access from the teacher's terminal 300, a URL of an application included in the app group 240 is determined as the application corresponding to the registration ID.

The authentication unit 230 compares account information input from the teacher's terminal 300 or the student's terminal 400 with user information stored in the user information storage unit 263, and performs authentication of the user (account information) in accordance with a result of the comparison.

The app group 240 is an example of applications of the server apparatus 200.

The app group 240 includes input apps and output apps. The input apps are, for example, applications that cause processes according to the usage to be performed. Each of the applications transmits, to the teacher's terminal 300 and the student's terminal 400, HTML data, a script, and like that cause a process according to the usage to be performed. The output apps are, for example, applications that cause acquisition (downloading) and rendering of image data stored in the submission material information storage unit 266 to be performed.

The app group 240 according to the present embodiment includes, for example, various applications that implement services provided by the server apparatus 200. The app group 240 according to the present embodiment includes, for example, a submission setting app 240-1, a questionnaire creation app 240-2, and a submission app 240-3.

The submission setting app 240-1 is an application that causes the teacher's terminal 300 to set information to be associated with a submission service implemented by the submission app 240-3.

That is, the submission setting app 240-1 is an example of a first setting unit configured to cause the teacher's terminal 300, which is a first terminal apparatus configured to request generation of a code, to set a first input item associated with a service. The value of the first input item indicates a submission destination of a submission material that is transmitted from the student's terminal 400 in response to the student's terminal 400 scanning the code.

The questionnaire creation app 240-2 is an application that causes a process of assisting creation of a questionnaire to be displayed on the student's terminal 400 in response to the student's terminal 400 scanning the code to be performed.

That is, the questionnaire creation app 240-2 is an example of a second setting unit configured to set a second input item to be displayed on the student's terminal 400 which is a second terminal apparatus configured to scan the code. The second input item is different from the first input item and is associated with the service. The value of the second input item indicates a reply to the questionnaire.

The submission app 240-3 stores, in a submission destination set by the teacher's terminal 300, a submission material transmitted from the student's terminal 400 in response to the student's terminal 400 scanning the code.

That is, the submission app 240-3 is an example of a storage control unit configured to cause information transmitted from the second terminal apparatus in response to the second terminal apparatus scanning the code to be stored in a storage destination included in the code.

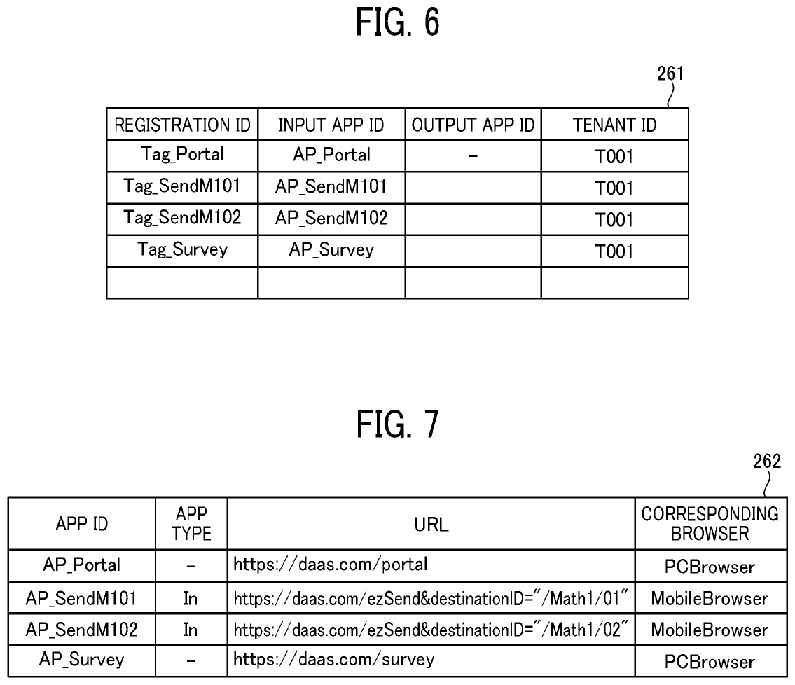

The registration information storage unit 261, the app information storage unit 262, the user information storage unit 263, the submission information storage unit 264, the questionnaire information storage unit 265, and the submission material information storage unit 266 of the server apparatus 200 will be described next with reference to FIGS. 6 to 11, respectively.

FIG. 6 is a diagram illustrating an example of the registration information storage unit according to the first embodiment. Registration information stored in the registration information storage unit 261 according to the present embodiment is information that is given in advance before operations (to be described below) of the information processing system 100 are performed.

The registration information storage unit 261 includes information items such as a registration ID, an input app ID, an output app ID, and a tenant ID. The value of the item “registration ID” is stored in association with the values of the other items. The input app ID and the output app ID may be collectively associated as an item “app ID” instead of distinguishing between the input app ID and the output app ID. The term “app ID” used herein refers to either the input app ID or the output app ID.

Examples of the identification information for identifying the submission service described above include registration IDs “Tag_Portal”, “Tag_SendM101”, “Tag_SendM102”, and “Tag_Survey” The submission service is implemented at least by apps respectively identified by app IDs “AP_Portal”, “AP_SendM101”, “AP_SendM102”, and “AP_Survey”.

The input app ID is identification information for identifying an application serving as an input app in the service corresponding to the registration ID. The output app ID is identification information for identifying an application serving as an output app in the service corresponding to the registration ID. In the following description, identification information for identifying an application is referred to as an “app ID”

For example, the registration ID “Tag_Portal” is associated with the input app ID “AP_Portal” but is not associated with any output app ID. This indicates that the service corresponding to the registration ID “Tag_Portal” is a service for transmitting, to the teacher's terminal 300 or the student's terminal 400, HTML data, a script, and the like that cause a process according to the usage to be performed.

The input app ID “AP_Portal” is an app ID of an application that causes a process of displaying a menu that is a portal screen for the teacher to be performed. That is, the application indicated by the app ID “AP_Portal” is the submission setting app 240-1.

The registration ID “Tag_SendM101” is associated with the input app ID “AP_SendM101” but is not associated with any output app ID. This indicates that the service corresponding to the registration ID “Tag_SendM101” is a service for transmitting, to the teacher's terminal 300 or the student's terminal 400, HTML data, a script, and the like that cause a process according to the usage to be performed.

The input app ID “AP_SendM101” is an app ID of an application that causes a process of storing a submission material including a questionnaire result to a folder “M101” which is the specified submission destination (storage destination) to be performed. That is, the application indicated by the app ID “AP_SendM101” is the submission app 240-3.

The input app ID “AP_SendM102” associated with the registration ID “Tag_SendM102” is substantially the same as the input app ID “AP_SendM101” and the registration ID “Tag_SendM101” except for the folder serving as the submission destination is replaced with the folder “M102”.

The registration ID “Tag_Survey” is associated with the input app ID “AP_Survey” but is not associated with any output app ID. This indicates that the service corresponding to the registration ID “Tag_Survey” is a service for transmitting, to the teacher's terminal 300 or the student's terminal 400, HTML data, a script, and the like that cause a process according to the usage to be performed.

The input app ID “AP_Survey” is an app ID of an application that assists creation of a questionnaire in the teacher's terminal 300. That is, the application indicated by the input app ID “AP_Survey” is the questionnaire creation app 240-2.

In the following description, information including the value of the item “registration ID” and the values of the other items in the registration information storage unit 261 is referred to as registration information.

FIG. 7 is a diagram illustrating an example of the app information storage unit according to the first embodiment. App information stored in the app information storage unit 262 according to the present embodiment is information that is given in advance before operations (to be described below) of the information processing system 100 are performed.

The app information storage unit 262 includes information items such as an app ID, an app type, a URL, and a corresponding browser. The item “app ID” and the other items are associated with each other.

The value of the item “app type” indicates a type based on a relationship between an application identified by the app ID and document image data. If the value of the item “app type” is “In”, the value indicates that the application identified by the app ID is an input app. If the value of the item “app type” is “Out”, the value indicates that the application identified by the app ID is an output app. This item may be omitted when the app type is not distinguished between the input app and the output app as described above.

The value of the item “URL” indicates a URL of the application identified by the app ID.

The value of the item “corresponding browser” indicates the type of the browser on which the application identified by the app ID operates. In the example illustrated in FIG. 7, the type of the browser indicates a terminal browser indicating a browser unit of the teacher's terminal 300 or the student's terminal 400.

In the following description, information including the values of the respective items in the app information storage unit 262 is referred to as app information.

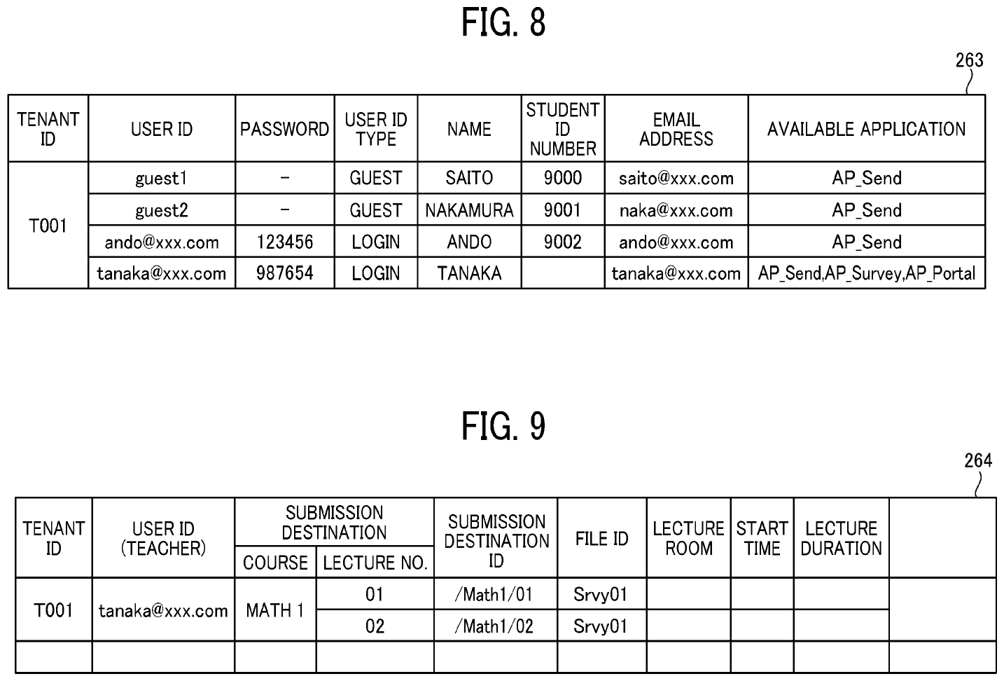

FIG. 8 is a diagram illustrating an example of the user information storage unit according to the first embodiment. User information stored in the user information storage unit 263 is information that is given in advance before operations (to be described below) of the information processing system 100 are performed.

The user information storage unit 263 includes information items such as a tenant ID, a user ID, a user ID type, a name, a student ID number, an email address, and an available application. The item “user ID” and the other items are associated with each other.

The value of the item “tenant ID” is identification information of a contractor (tenant) of a contract of using the service provided by the server apparatus 200. For example, the user environment E may correspond to one tenant.

The value of the item “user ID” is identification information for identifying a user of a terminal apparatus. Specifically, the value of the item “user ID” is identification information for identifying a teacher who is the user of the teacher's terminal 300 or identification information for identifying a student who is the user of the student's terminal 400. In the present embodiment, a user ID is assigned to each individual, that is, each of the teacher and student. The user ID may be an email address described later.

The value of the item “user ID type” indicates the type of the user ID. Specifically, if the value of the item “user ID type” is “guest”, the value indicates that login information including the user ID and password for identifying the user is not registered in the user information storage unit 263. If the value of the item “user ID type” is “login”, the value indicates that login information including the user ID and password for identifying the user is registered in the user information storage unit 263 and that the user logs in using the registered login information.

The value of the item “name” indicates the name of the user. The value of the item “student ID number” indicates the student ID number of the user (student). The value of the item “email address” indicates the email address of the user.

The value of the item “available application” indicates an app ID of an application which the corresponding user is permitted to use.

In the following description, information including the values of the respective items in the user information storage unit 263 is referred to as user information.

The example illustrated in FIG. 8 indicates that the user identified by the tenant ID “T001” and the user ID “guest1” is permitted to use an application identified by the app ID “AP_Send”. The application identified by the app ID “AP_Send” is an application that implements part of the submission service.

The example illustrated in FIG. 8 indicates that the user identified by the tenant ID “T001” and the user ID “tanaka@xxx.com” is permitted to use applications identified by the app IDs “AP_Send”, “AP_Survey”, and “AP_Portal” which are applications that implement part of the submission service.

Some of the information items of the user information according to the present embodiment illustrated in FIG. 8 may be omitted. In addition, the user information may additionally include an information item other than the information items illustrated in FIG. 8.

FIG. 9 is a diagram illustrating an example of the submission information storage unit according to the first embodiment. Submission information stored in the submission information storage unit 264 according to the present embodiment is generated in response to information indicating the storage destination (submission destination) of information being input to the teacher's terminal 300 and is then stored in the submission information storage unit 264.

The submission information storage unit 264 includes information items such as a tenant ID, a user ID, a submission destination, a submission destination ID, a file ID, a lecture room, a start time, a lecture duration. The item “user ID” and the other items are associated with each other.

The value of the item “user ID” is a user ID for mainly identifying a teacher. The item “submission destination” is further associated with items “course” and “lecture No.”. The value of the item “course” and the value of the item “lecture No.” are values of the classification of the submission destination set in introduction setting information and input by the teacher's terminal 300, and indicate the course name and the number assigned to a lecture of the course.

The value of the item “submission destination ID” is identification information for identifying a storage destination (memory region) in which a submission material (such as image data and a questionnaire result) transmitted from the student's terminal 400 is to be stored. Specifically, the value of the item “submission destination ID” is a name or the like of a folder serving as a storage destination of a submission material, and is created using the value of the item “submission destination”.

The value of the item “file ID” is identification information for identifying a questionnaire file registered in advance. The values of the items “lecture room”, “start time”, and “lecture duration” are information for identifying the room where the lecture is conducted, information indicating the start time of the lecture, and information indicating the duration of the lecture, respectively.

In the following description, information including the value of the item “user ID” and the values of the other items in the submission information storage unit 264 is referred to as submission information.

Some of the items of the submission information illustrated in FIG. 9 may be omitted. Specifically, for example, the items “lecture room”, “start time”, and “lecture duration” may be omitted. The submission information may additionally include an item other than the items illustrated in FIG. 9. The data structure of the submission information storage unit 264 may be set in any manner by the teacher who sets the submission destination of the submission material.

In the submission information storage unit 264 according to the present embodiment, for example, document data of a distribution material in which an answer is yet to be written may be stored in association with the user ID and the submission destination.

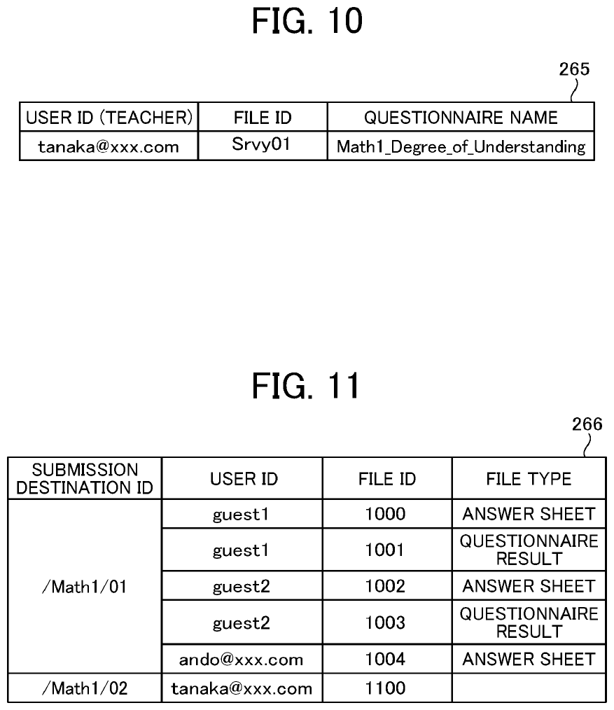

FIG. 10 is a diagram illustrating an example of the questionnaire information storage unit according to the first embodiment. Questionnaire information stored in the questionnaire information storage unit 265 according to the present embodiment is generated by the teacher's terminal 300 and is then stored in the questionnaire information storage unit 265.

The questionnaire information storage unit 265 includes information items such as a user ID, a file ID, and a questionnaire name. The items are associated with each other.

In the questionnaire information storage unit 265, the value of the item “user ID” is a user ID for mainly identifying a teacher. The value of the item “file ID” is identification information for identifying a questionnaire file. In the present embodiment, information including the value of the item “user ID” and the values of the other items in the questionnaire information storage unit 265 is referred to as questionnaire information.

The example illustrated in FIG. 10 indicates that the teacher identified by the user ID “tanaka@xxx.com” has created a questionnaire file that is identified by the file ID “Srvy01” and is assigned the questionnaire name“Math1_Degree_of_Understanding”.

FIG. 11 is a diagram illustrating an example of the submission material information storage unit according to the first embodiment. Submission material information stored in the submission material information storage unit 266 according to the present embodiment is generated in response to a submission material transmitted from the student's terminal 400 being stored in a folder identified by the submission destination ID.

The submission material information storage unit 266 includes information items such as a submission destination ID, a user ID, a file ID, and a file type. The item “user ID” and the other items are associated with each other.

The value of the item “user ID” is identification information for mainly identifying a user who is a student. The value of the item “file ID” is identification information for identifying a file transmitted from the student's terminal 400. The value of the item “file type” indicates a type of a submission material corresponding to the file.

FIG. 11 indicates that an answer file corresponding to an answer sheet identified by the file ID “1000” and a file corresponding to a questionnaire result identified by the file ID “1001” are stored in a folder identified by the submission destination ID “/Math1/01” as a submission material of the user (student) identified by the user ID “guest1”.

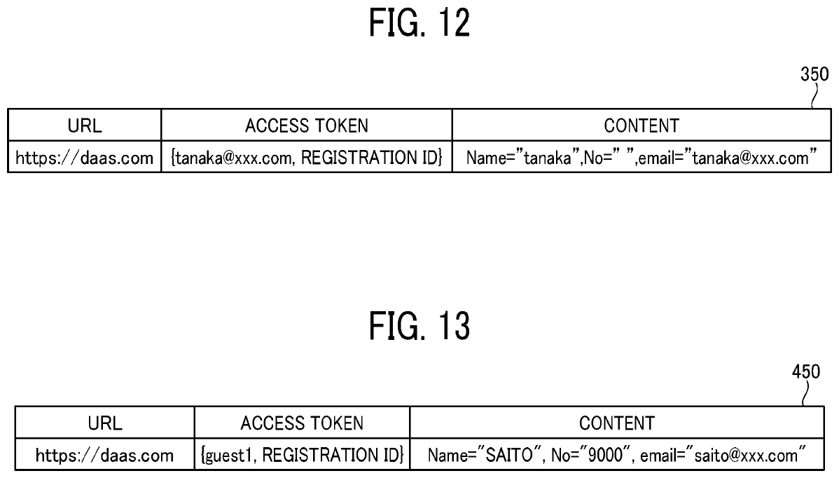

Information stored in the storage unit 350 of the teacher's terminal 300 and information stored in the storage unit 450 of the student's terminal 400 will be described next with reference to FIGS. 12 and 13, respectively.

FIG. 12 is a diagram illustrating information stored in the storage unit of the teacher's terminal according to the first embodiment. Information stored in the storage unit 350 of the teacher's terminal 300 includes, for example, items such as a URL, an access token, and content.

The value of the item “URL” indicates the server apparatus 200. The value of the item “access token” indicates the registration ID and the user ID. The value of the item “content” includes the name indicated by “Name”, the student ID number indicated by “No”, and the email address indicated by “email”.

The example illustrated in FIG. 12 illustrates the information stored in the storage unit 350 of the teacher's terminal 300. Thus, the user ID included in the access token is the user ID for identifying the teacher associated with the user ID type that is not “guest” but is “login”.

FIG. 13 is a diagram illustrating information stored in the storage unit of the student's terminal according to the first embodiment. Items of information stored in the storage unit 450 of the student's terminal 400 are substantially the same as the items of the information stored in the storage unit 350 of the teacher's terminal 300.

In the example illustrated in FIG. 13, the user ID included in the access token is “guest1”.

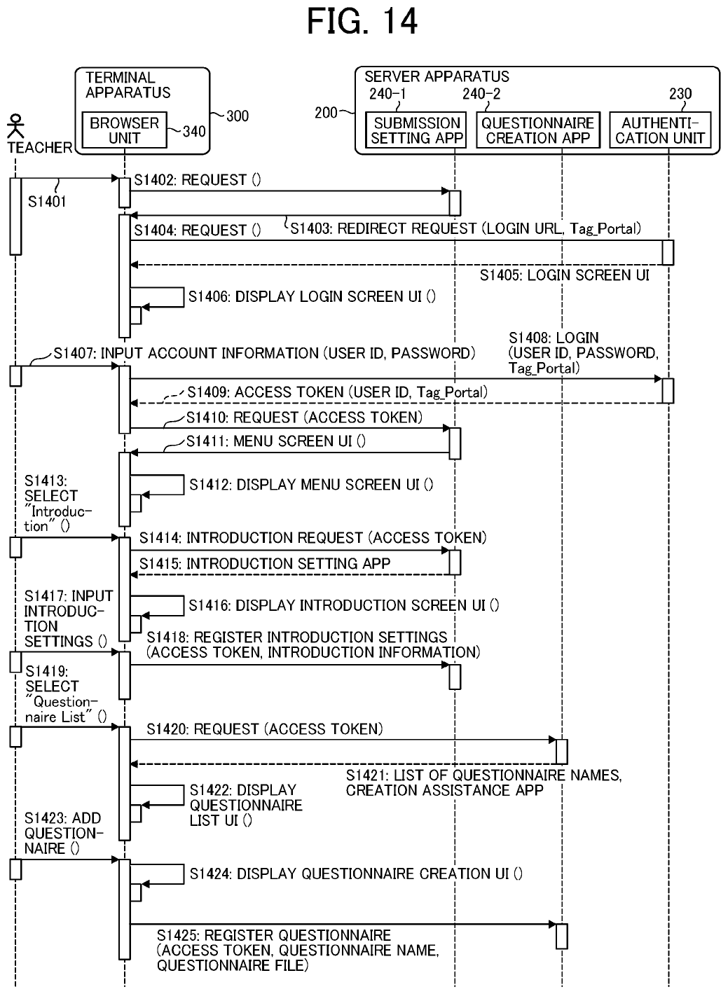

An operation of the information processing system 100 according to the present embodiment will be described next with reference to FIG. 14. FIG. 14 is a first sequence diagram illustrating an operation of the information processing system according to the first embodiment. An operation of setting information to be associated with the submission service will be described with reference to FIG. 14.

In the information processing system 100, in response to an access request to access the submission setting app 240-1 from a teacher (step S1401), the browser unit 340 of the terminal apparatus (teacher's terminal) 300 transmits, to the server apparatus 200, a connection request to connect to the submission setting app 240-1 (step S1402).

Since no access token is stored in the terminal apparatus 300 at the time of initial access, the connection request is transmitted without the access token.

In the server apparatus 200, since the connection request is a request from a client not having an access right, the submission setting app 240-1 returns, to the teacher's terminal 300, a redirect request to redirect the connection request to the authentication unit 230 (step S1403). The redirect request includes the URL of the authentication unit 230 and the registration ID “Tag_Portal” for identifying the service provided by the submission setting app 240-1.

In response to the redirect request to redirect the connection request to the authentication unit 230, the browser unit 340 transmits, to the server apparatus 200, a connection request to connect to the authentication unit 230 (step S1404). The authentication unit 230 transmits a URL of a login screen (step S1405).

The browser unit 340 then causes the login screen to be displayed (step S1406). In response to input of account information in the login screen (step S1407), the browser unit 340 transmits a login request including the account information to the authentication unit 230 of the server apparatus 200 (step S1408). The account information according to the present embodiment includes the user ID, the password, and the registration ID (“Tag_Portal”) associated with the submission setting app 240-1.

The authentication unit 230 of the server apparatus 200 then refers to the user information storage unit 263 and determines whether the user ID that matches the user ID included in the account information is found in the user information storage unit 263 and whether the application associated with the registration ID included in the account information is included in the available applications associated with this user ID.

Specifically, for example, suppose that the user ID input to the teacher's terminal 300 is “tanaka@xxx.com”.

In this case, the authentication unit 230 determines that the user ID that matches the user ID “tanaka@xxx.com” is found in the user information storage unit 263. In the registration information storage unit 261, the application associated with the registration ID “Tag_Portal” is the submission setting app 240-1 identified by the app ID “AP_Portal” (see FIGS. 6 and 8).

The authentication unit 230 determines whether the app ID “AP_Portal” is included in the available applications associated with the user ID “tanaka@xxx.com”. In the present embodiment, the app ID “AP_Portal” is included in the available applications associated with the user ID “tanaka@xxx.com” in the user information storage unit 263. Thus, the authentication unit 230 permits this user to use the submission setting app 240-1 identified by the app ID “AP_Portal”.

Specifically, the authentication unit 230 creates an access token for accessing the user information corresponding to the user ID “tanaka@xxx.com” and returns the access token to the browser unit 340 (step S1409). The browser unit 340 stores this access token.

Then, the browser unit 340 uses the acquired access token and transmits, to the server apparatus 200, a connection request to connect to the submission setting app 240-1 associated with the registration ID for which the use is permitted (step S1410).

In the server apparatus 200, in response to the connection request, the submission setting apps 240-1 returns, to the teacher's terminal 300, a URL of a menu screen that allows the teacher to set information to be associated with the service (step S1411).

In response to receipt of this URL (step S1411), the browser unit 340 of the teacher's terminal 300 causes the menu screen to be displayed which allows the teacher to set information to be associated with the service (step S1412).

In this case, a menu screen is to be displayed which allows the teacher to set information to be associated with the submission app 240-3.

More specifically, the menu screen includes “Introduction”, “Questionnaire List”, and “Submission Destination”. Selection of “Introduction” in the menu screen causes the browser unit 340 to transition to a process of setting input items for which values are to be input by the teacher's terminal 300 when a code is generated.

Selection of “Questionnaire List” in the menu screen causes the browser unit 340 to transition to a process of creating a questionnaire to be displayed on the student's terminal 400 in response to the student's terminal 400 scanning the code.

Selection of “Submission Destination” in the menu screen causes the browser unit 340 to transition to a process of acquiring a code that associates the service with the set information.

In response to selection of “Introduction” in the menu screen (step S1413), the browser unit 340 transmits an introduction request to the submission setting app 240-1 (S1414). The introduction request includes an access token. In response to the introduction request, the submission setting app 240-1 returns an application for performing introduction settings to the teacher's terminal 300 (step S1415). In the following description, the application for performing introduction settings is referred to as an “introduction setting app”.

The browser unit 340 of the teacher's terminal 300 receives and executes the introduction setting app to cause the introduction setting app to display an introduction screen (step S1416).

In response to input of introduction settings (step S1417), the browser unit 340 makes settings in accordance with transition of the screen caused by the introduction setting app, and transmits the set introduction setting information along with the access token including the user ID to the submission setting app 240-1 to register the user ID and the introduction setting information in the submission setting app 240-1 in association with each other (step S1418).

In the present embodiment, information set by the introduction setting app includes input items for which values are input by the teacher's terminal 300 when a code to be given to a distribution material in the submission service is generated. Details of the settings made by the introduction setting app will be described later.

In response to selection of “Questionnaire List” in the menu screen (step S1419), the browser unit 340 of the teacher's terminal 300 transmits, to the questionnaire creation app 240-2, a display request to display a list of created questionnaires (S1420).

In the present embodiment, in response to selection of “Questionnaire List” in the introduction setting app, the questionnaire creation app 240-2 identified by the app ID “AP_Survey” is accessed. However, a method of accessing the questionnaire creation app 240-2 is not limited to this one. For example, if the user directly accesses the questionnaire creation app 240-2 without via the introduction setting app, the registration ID “Tag_Survey” is included in the QR code 21. Consequently, the questionnaire creation app 240-2 is successfully identified based on the registration information storage unit 261 illustrated in FIG. 6.

In response to the display request, the questionnaire creation app 240-2 refers to the questionnaire information storage unit 265 and transmits, to the terminal apparatus 300, a list of questionnaire names associated with the user ID and an application for assisting creation of a questionnaire (step S1421). If there is no questionnaire name associated with the user ID, the list of questionnaire names is not transmitted. In the following description, the application for assisting creation of a questionnaire is referred to as a “creation assistance app”.

The browser unit 340 of the teacher's terminal 300 executes the received creation assistance app and causes the creation assistance app to display the received list of questionnaire names (step S1422). If there is no questionnaire name associated with the user ID in the questionnaire information storage unit 265, the browser unit 340 does not receive the list of questionnaire names. Thus, a blank screen is displayed by the creation assistance app in step S1422.

In response to an operation to add a questionnaire (step S1423), the browser unit 340 of the teacher's terminal 300 causes the creation assistance app to display a questionnaire creation screen (step S1424).

In response to the completion of creation of the questionnaire, the browser unit 340 transmits a questionnaire registration request to the questionnaire creation app 240-2 (step S1425). The questionnaire registration request includes an access token, a questionnaire name, and a questionnaire file.

In response to the questionnaire registration request, the questionnaire creation app 240-2 stores the user ID included in the access token, the questionnaire name, and the file ID of the questionnaire file in the questionnaire information storage unit 265 in association with each other.

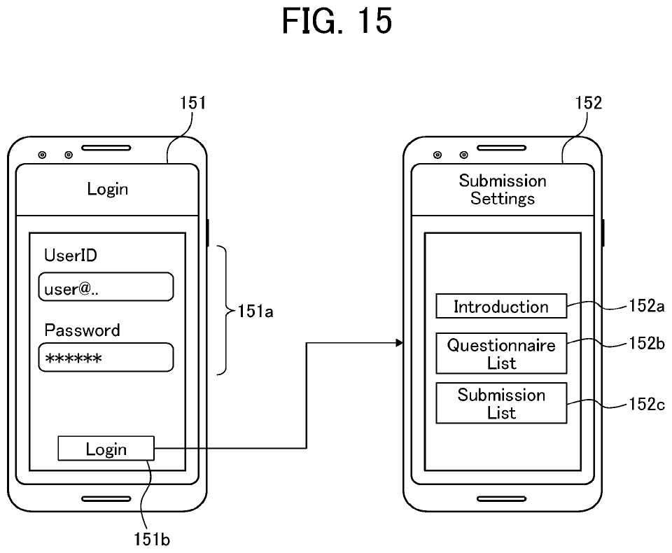

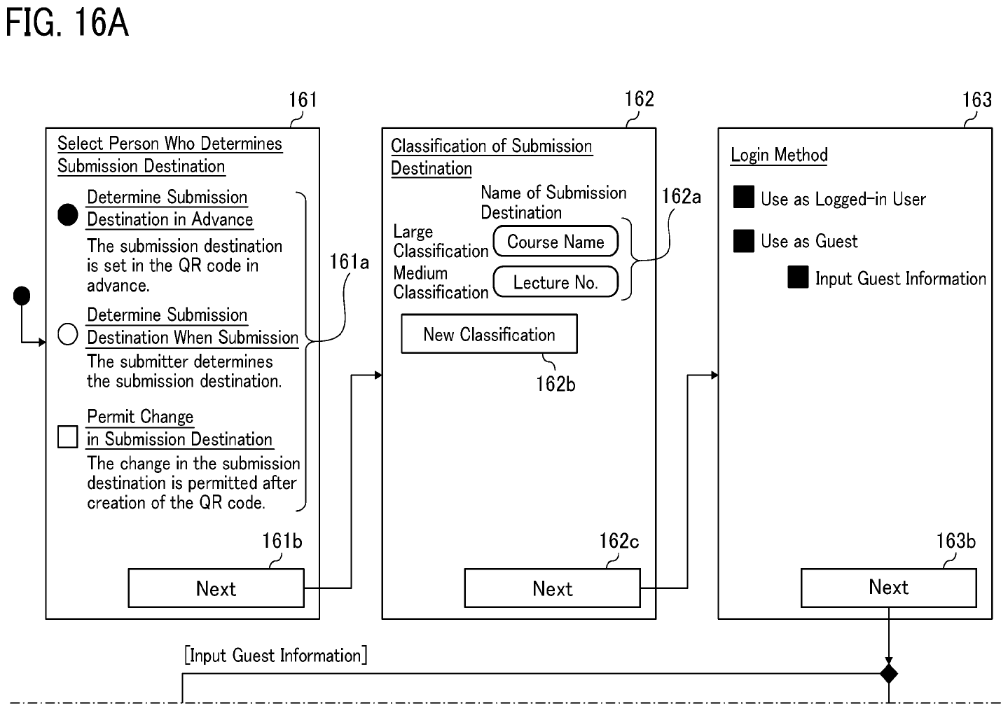

Transition of the screen on the teacher's terminal 300 in the operation illustrated in FIG. 14 will be described below with reference to FIGS. 15 to 17.

FIG. 15 is a first diagram illustrating transition of the screen on the teacher's terminal according to the first embodiment. A screen 151 illustrated in FIG. 15 is an example of the login screen displayed in step S1406 illustrated in FIG. 14.

In the screen 151, an entry field 151a for account information (a user ID and a password) and an operation key 151b are displayed.

Account information is input in the entry field 151a, and the operation key 151b is operated. This operation causes the screen 151 to transition to a screen 152.

The screen 152 is an example of the menu screen displayed in step S1412 illustrated in FIG. 14. In the screen 152, operation keys 152a, 152b, and 152c are displayed.

In response to an operation of the operation key 152a in the screen 152, the browser unit 340 causes the screen 152 to transition to the setting screen displayed by the introduction setting app.

In response to an operation of the operation key 152b in the screen 152, the browser unit 340 causes the screen 152 to transition to the setting screen displayed by the creation assistance app.

In response to an operation of the operation key 152c in the screen 152, the browser unit 340 causes the screen 152 to transition to a code creation screen.

In the present embodiment, introduction settings are made with the introduction setting app in response to selection of the operation key 152a. After the introduction settings are finished, the operation keys 152b and 152c are displayed. Thus, when introduction settings are not finished, the operation keys 152b and 152c are not displayed in the screen 152 or are displayed in an unselectable state.

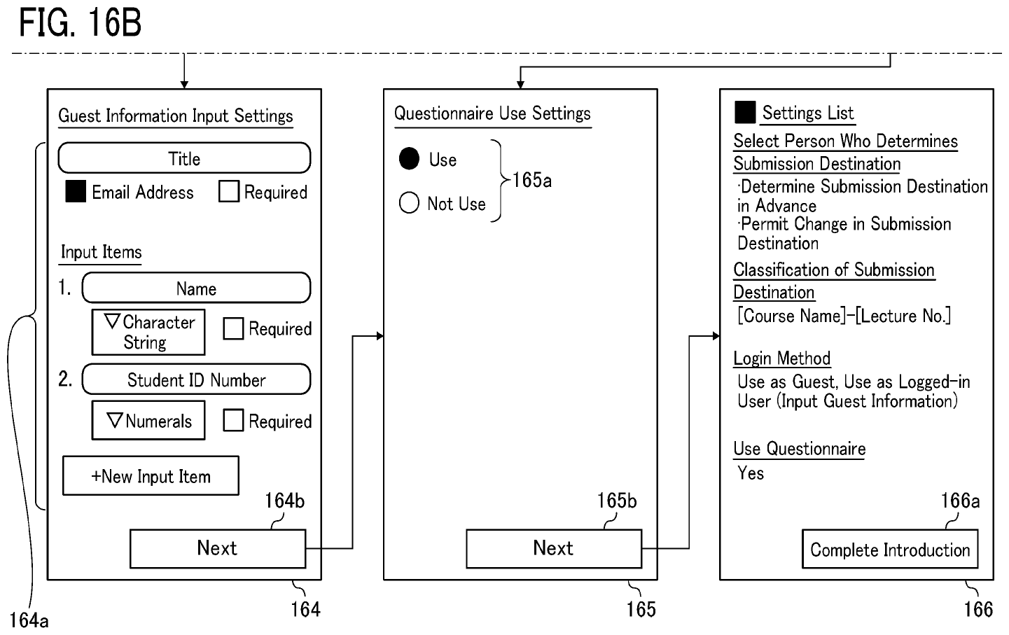

FIG. 16 is a second diagram illustrating transition of the screen on the teacher's terminal according to the first embodiment. FIG. 16 illustrates an example of transition of the screen displayed by the introduction setting app in response to an operation of the operation key 152a in the screen 152.

An operation of the operation key 152a causes the screen 152 to transition to a screen 161 illustrated in FIG. 16. The screen 161 is an example of the screen displayed in step S1416 illustrated in FIG. 14.

In the screen 161, a display field 161a and an operation key 161b are displayed. In the display field 161a, alternatives of selecting a person who determines a submission destination of a submission material are displayed. Specifically, in the display field 161a, three alternatives “Determine Submission Destination in Advance”, “Determine Submission Destination When Submission”, and “Permit Change in Submission Destination” are displayed.

The example illustrated in FIG. 16 describes the case where the alternative “Determine Submission Destination in Advance” is selected and the operation key 161b is operated.

The operation of the operation key 161b causes transition of the screen 161 to a screen 162. In the screen 162, an entry field 162a and operation keys 162b and 162c are displayed. Classification of the submission destination is input in the entry field 162a. Classification of the submission destination indicates a layer of a folder serving as the submission destination, and indicates items for which values are to be input by the teacher's terminal 300 when a code is generated.

In response to the operation of the operation key 162b in the screen 162, a new classification entry field is added to the entry field 162a.

In the example illustrated in FIG. 16, two layers, i.e., a large classification and a medium classification, have been added. A submission destination name may be input in association with a classification of each submission destination. The input submission destination name may be registered as a name of the corresponding folder. The example illustrated in FIG. 16 indicates that a folder for a classification “Lecture No.” can be specified under a folder for a classification “Course Name”. Alternatively, a classification of the submission destination that is displayed by default may be set. For example, when the large classification “Course Name” and the medium classification “Lecture No.” displayed in FIG. 16 are set as the classification of the submission destination that is displayed by default, the large classification “Course Name” and the medium classification “Lecture No.” are displayed in response to an operation of the operation key 161b.

Deletion of an already added classification may be permitted as well as addition of a new classification of the submission destination.

The classification of the submission destination is input in the entry field 162a, and the operation key 162c is operated. This operation causes transition of the screen 162 to a screen 163.

The screen 163 is a screen in which a login method for using the submission app 240-3 is set. The screen 163 displays alternatives of the login method, i.e., a method prompting the user to input the account information to log in and a method permitting the user to log in as a guest.

In the screen 163, both the method prompting the user to input the account information to log in and the method permitting the user to log in as a quest are selected, and an operation key 163a is operated. This operation causes transition of the screen 163 to a screen 164.

If the method prompting the user to input the account information to log in alone is selected and the operation key 163a is operated in the screen 163, the screen 163 transitions to a screen 165 (described later).

In the screen 164, an entry field 164a and an operation key 164b are displayed. The entry field 164a accepts specifying of items of guest information to be input when the user logs in as a guest.

The entry field 164a includes items of the guest information such as an email address, a name, and a student ID number. The items specified in the entry field 164a serve as items to be input as the guest information from the student's terminal 400.

That is, in the screen 164, items to be input by a terminal apparatus of a user of the submission app 240-3 (the student's terminal 400 in response to the student's terminal 400 scanning the QR code 21) are set. An operation of the operation key 164b in the screen 164 causes the screen 164 to transition to the screen 165.

In the screen 165, a selection field 165a and an operation key 165b are displayed. In the selection field 165a, a setting as to whether or not to use a questionnaire is made. In the selection field 165a, two alternatives of selecting whether or not to use a questionnaire are displayed.

The example illustrated in FIG. 16 describes the case where the user select to “Use” a questionnaire. “Use” of the questionnaire is selected in the selection field 165a of the screen 165, and the operation key 165b is operated. This operation causes transition of the screen 165 to a screen 166.

In the screen 166, a list of settings made by the introduction setting app is displayed. In the following description, information set by the introduction setting app may be also referred to as introduction setting information. As indicated by the screen 166 illustrated in FIG. 16, the introduction setting information includes information indicating items for which values are to be input by the teacher's terminal 300 when a code is generated.

In the present embodiment, the introduction setting information may be stored in the server apparatus 200 in association with the user ID as described above. Alternatively, the introduction setting information may be stored by the introduction setting app.

An operation of an operation key 166a in the screen 166 causes transition of the screen 166 to the screen 152 illustrated in FIG. 15. In the case where the operation key 152a is selectable in the screen 152 and the introduction setting information is stored, the browser unit 340 may read the introduction setting information and cause the screen 152 to transition to the screen 166.

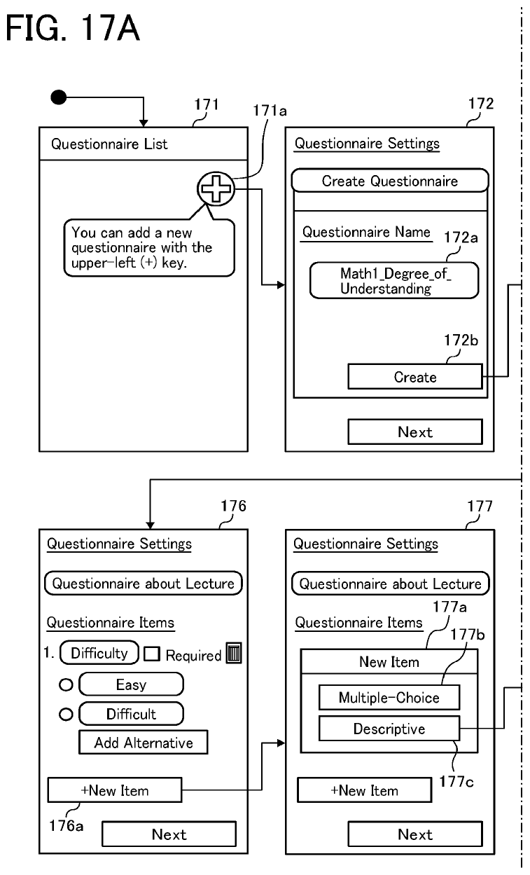

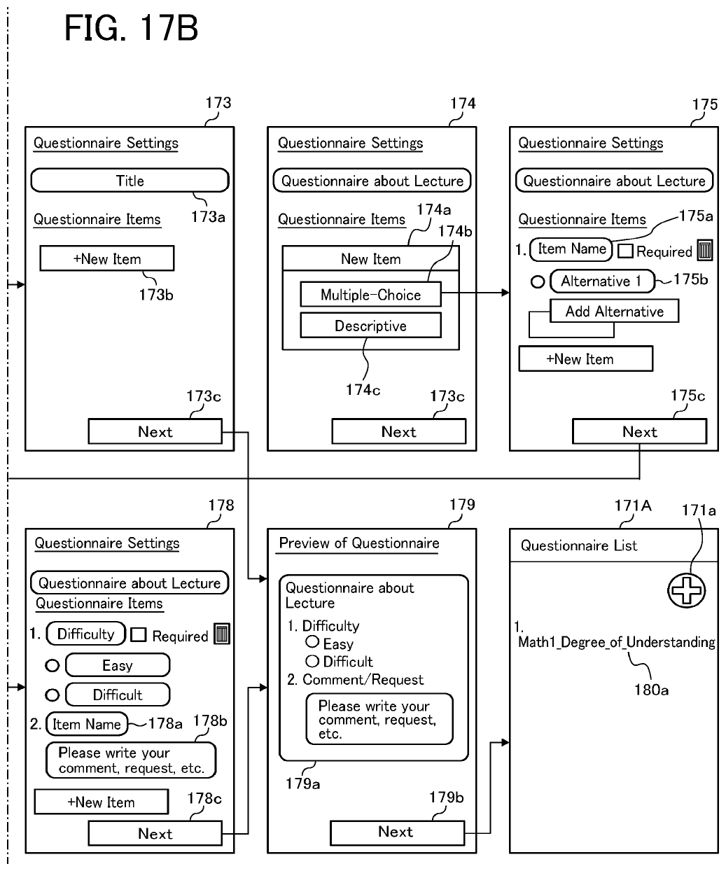

Transition of the screen on the teacher's terminal 300 in response to selection of the operation key 152b in the screen 152 illustrated in FIG. 15 will be described next with reference to FIG. 17.

FIG. 17 is a third diagram illustrating transition of the screen on the teacher's terminal according to the first embodiment. FIG. 17 illustrates an example of transition of the screen displayed by the creation assistance app in response to the operation of the operation key 152b in the screen 152.

The operation of the operation key 152b in the screen 152 causes the screen 152 to transition to a screen 171. The screen 171 is an example of the screen displayed in step S1422 illustrated in FIG. 14. In the screen 171, an operation key 171a and a message indicating that a questionnaire is addable are displayed. The screen 171 indicates that there is no questionnaire file associated with the user ID.

An operation of the operation key 171a in the screen 171 causes the screen 171 to transition to a screen 172. The screen 172 is an example of the screen displayed in step S1424 illustrated in FIG. 14.

In the screen 172, an entry field 172a for a questionnaire name and an operation key 172b are displayed. The questionnaire name is input, and the operation key 172b is operated in the screen 172. This operation causes transition of the screen 172 to a screen 173.

In the screen 173, an entry field 173a and operation keys 173b and 173c are displayed. A theme of the questionnaire is input in the entry field 173a. The operation key 173b is an operation key for adding a question to be replied by students in the questionnaire. The operation key 173c is an operation key for causing transition to a screen 179 (described later).

In the screen 173, the theme of the questionnaire is input in the entry field 173a, and the operation key 172b is operated. This operation causes transition of the screen 173 to a screen 174.

In the screen 174, a display field 174a is displayed. In the display field 174a, alternatives of selecting an input format of a reply to a new question to be added are displayed. Specifically, the display field 174a includes a selection key 174b for a selection format that prompts the student to select the reply from alternatives and a selection key 174c for a descriptive format that prompts the student to write the reply.

FIG. 17 describes the case where the selection key 174b is operated in the display field 174a. This operation of the selection key 174b causes the screen 174 to transition to a screen 175.

In the screen 175, an entry field 175a for inputting a question to be included in the questionnaire is displayed. In the screen 175, an entry field 175b for inputting an alternative of the reply to the question is also displayed.

In the screen 175, a question is input in the entry field 175a, an alternative of the reply is input in the entry field 175b, and an operation key 175c is operated. This operation causes transition of the screen 175 to a screen 176.

The screen 176 indicates that “Difficulty” is input as a question to be included in the questionnaire assigned the questionnaire name “Mathl Degree_of Understanding”, and that “Easy” and “Difficult” are input as alternatives of the reply to the question.

An operation of an operation key 176a for adding a new question in the screen 176 causes the screen 176 to transition to a screen 177.

In the screen 177, a display field 177a is displayed. The display field 177a includes a selection key 177b for a selection format that prompts the student to select the reply to the question from alternatives and a selection key 177c for a descriptive formant that prompts the student to write the reply.

The screen 177 indicates the case where the selection key 177c is selected in the display field 177a. The operation of the selection key 177c in the screen 177 causes the screen 177 to transition to a screen 178.

In the screen 178, an entry field 178a for inputting a new question to be added is displayed. In the screen 178, a reply entry field 178b is displayed in association with the entry field 178a. In the screen 178, an operation key 178c is also displayed.

In the screen 178, a question is input in the entry field 178a, and the operation key 178c is operated. The operation of the operation key 178c causes the screen 178 to transition to the screen 179.

In the screen 179, a display field 179a and an operation key 179b are displayed. A preview of the questionnaire is displayed in the display field 179a. In the example illustrated in FIG. 17, a questionnaire including a question 1 in a multiple-choice format and a question 2 in a reply descriptive format is displayed as a questionnaire assigned a theme “Questionnaire about Lecture” in the display field 179a.

In response to the operation of the operation key 179b in the screen 179, the questionnaire displayed in the display field 179a is registered in the questionnaire creation app 240-2 as a questionnaire file assigned the questionnaire name “Math1_Degree_of_Understanding”, and the screen 179 transitions to a screen 171A.

Specifically, the questionnaire displayed in the display field 179a is output as a questionnaire file in the JavaScript Object Notation (JSON) format, for example. The questionnaire file is assigned a file ID “Srvy01” by the questionnaire creation app 240-2 and is stored in the questionnaire information storage unit 265 in association with the questionnaire name and the user ID.

The screen 171A indicates that a file assigned the questionnaire name “Math1_Degree_of Understanding” is registered as a questionnaire file associated with the user ID.

As described above, in the present embodiment, before the QR code 21 to be scanned by the student's terminal 400 is generated, items to be input as the submission destination of a submission material and items to be input with the student's terminal 400 as a reply to a questionnaire, which are different from the items to be input as the submission destination of the submission material, are set with the teacher's terminal 300.

The items to be input as the submission destination of a submission material are included in the introduction setting information set by the introduction setting app provided by the submission setting app 240-1 to the teacher's terminal 300.

The items to be input as a reply to a questionnaire are included in a questionnaire (information associating a question and a reply field for the question) created by the creation assistance app provided by the questionnaire creation app 240-2 to the teacher's terminal 300.

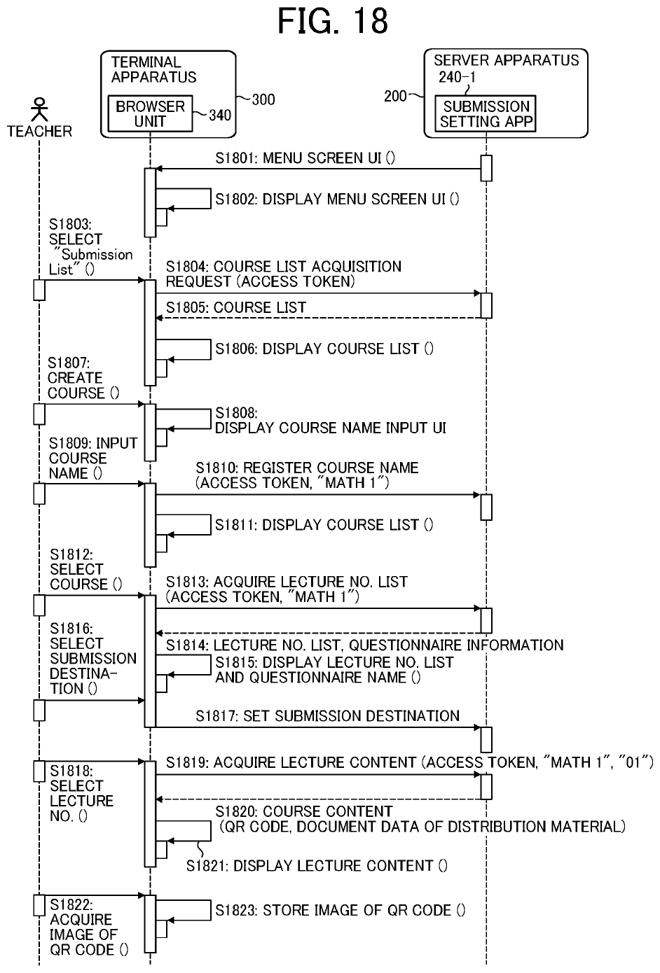

An operation of generating the QR code 21 will be described next with reference to FIG. 18. FIG. 18 is a second sequence diagram illustrating the operation of the information processing system according to the first embodiment.

Processing of steps S1801 and S1802 illustrated in FIG. 18 are substantially the same as the processing of steps S1411 and S1412 illustrated in FIG. 14, respectively.

In response to selection of “Submission List” in the menu screen displayed in step S1802 (step S1803), the browser unit 340 of the teacher's terminal 300 transmits, to the submission setting app 240-1, an acquisition request to acquire a list of lectures associated with the user ID (step S1804). The acquisition request includes an access token including the user ID.

In the server apparatus 200, the submission setting app 240-1 refers to the submission information storage unit 264, acquires a list of lectures associated with the user ID included in the access token, and returns the list of lectures to the browser unit 340 (step S1805). The browser unit 340 causes the acquired list of lectures to be displayed (step S1806). When “Submission List” is selected for the first time in the menu screen, no submission information is stored in association with the user ID. Thus, the list is not displayed.

The browser unit 340 then accepts an instruction to start setting of a lecture to be associated with a submission destination of a submission material (step S1807), and causes an input screen of the classification of the submission destination set in the introduction setting information to be displayed (step S1808).

The example illustrated in FIG. 18 illustrates the case where the large classification in the classification of the submission destination set in the introduction setting information is “Course Name”. If the introduction setting information is stored in association with the submission setting app 240-1, the introduction setting information associated with the user ID included in the access token is received from the submission setting app 240-1 along with the list of lectures in S1805 Consequently, the classification of the submission destination set in the introduction setting information can be identified and displayed.

In response to input of the classification (course name) of the submission destination (step S1809), the browser unit 340 transmits a registration request to register the course name to the submission setting app 240-1 (step S1810). The registration request includes the input course name and the access token. In response to the registration request, the submission setting app 240-1 stores the course name and the user ID included in the access token in the submission information storage unit 264 in association with each other. The browser unit 340 then causes the list of course names registered in the submission information storage unit 264 to be displayed (step S1811).

In response to selection of a course name (step S1812), the browser unit 340 transmits, to the submission setting app 240-1, an acquisition request to acquire a list of medium classifications (lecture No.) which is the lower-layer classification of the submission destination of the selected course name, based on the classification of the submission destination set in the introduction setting information (step S1813). This acquisition request includes the access token. If the lower-layer classification of the submission destination of the course name is not set in the setting of the classification of the submission destination of the introduction setting information, the request to acquire the list of medium classifications may be omitted.

The lecture No. indicates, for example, the number of lectures performed in the course assigned the course name. For example, in the case where the course name is “Math 1”, the lecture No. for the first lecture of Math 1 is “1”, and the lecture No. for the second lecture of Math 1 is “2”.

In response to the acquisition request, the submission setting app 240-1 refers to the submission information storage unit 264, acquires a list of lecture Nos. and a list of questionnaires that are associated with the user ID included in the access token and the course name, and returns the lists to the browser unit 340 (step S1814) At that time, the submission setting app 240-1 also returns the number of submission materials to the browser unit 340.

The submission setting app 240-1 refers to the introduction setting information and the submission information storage unit 264, and identifies the file ID of the questionnaire file corresponding to a set of the user ID, the course name of the classification of the submission destination, and the case where “Use” is set for the questionnaire use setting in the introduction setting information. The submission setting app 240-1 then refers to the questionnaire information storage unit 265 and acquires the questionnaire name corresponding to the file ID.

The browser unit 340 causes the list of lecture Nos. and the list of questionnaires to be displayed (step S1815). At that time, the browser unit 340 also causes the number of submission materials to be displayed in addition to the list of lecture Nos. and the list of questionnaires.

When no lecture No. is set in association with the user ID and the course name, the browser unit 340 does not receive the list of lecture Nos. from the submission setting app 240-1. In the case where the list of lecture Nos. is received, the browser unit 340 receives a setting request to set the lecture No. serving as the submission destination from the list of lecture Nos. (step S1816), and transmits, to the submission setting app 240-1, a registration request to register the lecture No. as the setting of the submission destination (step S1817).

This registration request includes the access token. In response to the registration request, the submission setting app 240-1 stores the selected lecture No. in the “lecture No.” of the item “submission destination” in the submission information storage unit 264. In the example illustrated in FIG. 18, the values of the large classification (course name) and the medium classification (lecture No.) set in the introduction setting information are set as the classification of the submission destination through this processing.

In the example illustrated in FIG. 18, the value of the course name is set to “Math 1”, and the value of the lecture No. is set to “1st Lecture”. Note that the classification of the submission destination based on the course name and the lecture No. is merely an example. The user may set another classification when setting the classification of the submission destination in the introduction settings.

If no lecture No. is set in association with the user ID and the course name that are desired by the teacher, the teacher can set (add) in step S1816 the lecture No. based on the medium classification (lecture No.) of the classification of the submission destination set in the introduction setting information. In step S1817, the browser unit 340 transmits a registration request to register the set (added) lecture No. to the submission setting app 240-1. The submission setting app 240-1 sets the set (added) lecture No. in the item “lecture No.” of the item “Submission Destination” in the submission information storage unit 264.

When the lecture No. and the file ID of the questionnaire that are associated with the user ID are not found in the submission information storage unit 264, the list of lecture Nos. and the list of questionnaires are not displayed in step S1815. The case where the list of lecture Nos. and the list of questionnaires are not displayed is at the time of introduction in which settings of the lecture No. and the questionnaire have not been performed.

The browser unit 340 then accepts selection of the lecture No. as part of information that indicates the submission destination and that is to be associated with the identification information for identifying the service included in the QR code 21 (step S1818).

The browser unit 340 then transmits, to the submission setting app 240-1, an acquisition request to acquire a list of lecture content of the selected lecture (step S1819). This acquisition request includes the course name and the lecture No. which are the classification of the submission destination, and the access token including the user ID.

The lecture content according to the present embodiment includes, for example, document data of the distribution material stored in the server apparatus 200 in association with the course name and the lecture No. which are the classification of the submission destination included in the acquisition request to acquire the list of content, image data of the QR code to be printed on the distribution material, and the submission material (image data of a captured image of the filled-in distribution material and the questionnaire result). Thus, the acquisition request includes the request to generate the QR code 21. In the case where the distribution material having an image based on the image data of the QR code is not distributed yet and the submission material is not collected yet, the browser unit 340 does not receive the submission material from the server apparatus 200.

In response to the acquisition request, the submission setting app 240-1 generates the QR code 21 to be given to the distribution material 20 and returns the list of lecture content including the image data representing the QR code 21 to the browser unit 340 (step S1820). Thus, the submission setting app 240-1 is also an example of a code generation unit configured to generate the QR code 21. A method of generating the QR code 21 performed by the submission setting app 240-1 will be described later.

The browser unit 340 causes the list of lecture content to be displayed (step S1821).

Since the distribution material is not distributed yet, the submission material is not present at this point. Thus, the document data of the distribution material 20 and the QR code 21 are displayed as the list of lecture content. Specifically, in step S1821, the browser unit 340 causes an operation key for inputting an instruction to display the image data of the QR code 21 and a thumbnail image of the document data of the distribution material 20 to be displayed.

In response to selection of the QR code 21 in the list of lecture content, the browser unit 340 regards the selection as acceptance of a display request to display the image data of the QR code 21 (step S1822) and causes the image data of the QR code 21 to be displayed (step S1823). At that time, the browser unit 340 stores the image data representing the QR code 21.

The submission setting app 240-1 according to the present embodiment generates the QR code 21 including a registration ID for identifying the submission service for transmitting a submission material to a submission destination indicated by the selected course name and lecture No. Specifically, the submission setting app 240-1 retrieves the registration ID associated with the app ID “AP_Send” indicating the available app associated with the user ID in the user information storage unit 263 and includes this registration ID in the QR code 21. Generation of the QR code 21 will now be described. In the present embodiment, the registration ID is embedded in the QR code 21. Methods of generating the QR code 21 will be described below.

### Method 1: Method of Describing the Registration ID as a Query Parameter

This method is used when the account information (user ID and password) of the user who makes a request to generate the QR code 21 is stored in the user information storage unit 263 and the tenant ID is included in the information items of the registration information storage unit 261. This method is usable even if the user who makes a request to generate the QR code 21 does not have the account information as long as there is no overlapping tenant ID.

When the method 1 is used, the format of retrieving the registration ID from the QR code 21 is, for example, “https://daas.com/start.html?tag=Tag_SendM101”.

In this case, information on the submission destination is identified from the URL stored in the app information storage unit 262 in association with the app ID “AP_SendM101” corresponding to the registration ID “Tag_SendM101” (see FIGS. 6 and 7).

### Method 2: Method of Describing the Registration ID and the Tenant ID as Query Parameters

In this method, inclusion of the tenant ID allows for the use of the same registration ID between tenants. Consequently, the item “tenant ID” may be omitted in the registration information storage unit 261. When the method 2 is used, the format of retrieving the registration ID from the QR code 21 is, for example, “https://daas.com/start.html?Tag_SendM101&tenant=T001”.

### Method 3: Method of Describing the Registration ID as a Web Application Programming Interface (API)

This method functions in substantially the same manner as the method 1 but can shorten the URL. When the method 3 is used, the format of retrieving the registration ID from the QR code 21 is, for example, “https://daas.com/Tag_SendM101”.

Method 4: Method of Describing Each Registration ID with a Static HTML File

This method functions in substantially the same manner as the method 1 but can shorten the URL. When the method 4 is used, the format of retrieving the registration ID from the QR code 21 is, for example, “https://daas.com/Tag_SendM101.html”.

The registration ID and the information on the submission destination may be embedded in the QR code 21. The method used in this case will be described below as a method 5.

### Method 5: Method of Describing the Registration ID, the Tenant ID, and the Submission Destination as Query Parameters

In this method, the submission destination is included in the QR code 21. Consequently, creation of the registration ID for each submission destination may be omitted.

Specifically, for example, when this method is used to create the QR code 21, “M101” indicating the folder serving as the submission destination may be omitted from the registration ID corresponding to an application for performing a process of storing a submission material in the folder “M101” specified as the submission destination. Accordingly, in this case, the app ID of the application for performing the service for storing a submission material in the specified submission destination is “AP_Send”. This indicates that the app ID is no longer to be distinguished between “M101” and “M102” that indicate the folders serving as the submission destination as in FIG. 7. In this case, the registration ID is “Tag_Send”. Thus, the registration ID is no longer to be distinguished between “M101” and “M102” that indicate the folders serving as the submission destination as in FIG. 6.

When the QR code 21 includes information indicating the folder serving as the submission destination, the value of the item “available application” in the user information storage unit 263 illustrated in FIG. 8 is the app ID “AP_Send”. When the QR code 21 does not include information indicating the folder serving as the submission destination, the value of the item “available application” is the app IDs that distinguish between the submission destinations such as the app ID “AP_SendM101”.

When the method 5 is used, the format of retrieving the registration ID from the QR code 21 is, for example, “https://daas.com/start.html?Tag SendM101&tenat=T001&destinationID=”/Math1/01”.

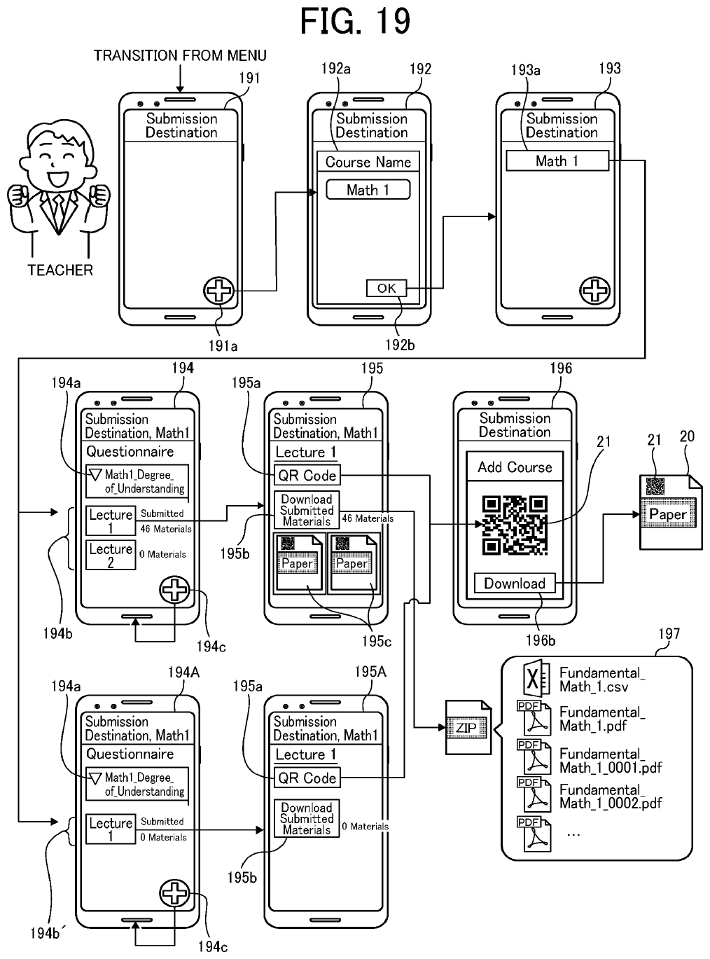

Transition of the screen on the teacher's terminal 300 in the operation illustrated in FIG. 18 will be described below with reference to FIG. 19.

FIG. 19 is a fourth diagram illustrating transition of the screen on the teacher's terminal according to the first embodiment. A screen 191 illustrated in FIG. 19 is a screen that transitions from the screen 152 in response to selection of the operation key 152c in the screen 152 illustrated in FIG. 15 and is an example of the screen displayed in step S1806 illustrated in FIG. 18.

Since no submission destination is set yet, an operation key 191a for adding a lecture to be associated with a submission destination alone is displayed in the screen 191. The operation of the operation key 191a in the screen 191 causes the screen 191 to transition to a screen 192. The screen 192 is an example of the screen displayed in step S1808 illustrated in FIG. 18.

In the screen 192, an entry field 192a for inputting a course name and an operation key 192b for instructing registration of the course name are displayed. The course name is input in the entry field 192a and the operation key 192b is operated. This operation causes transition of the screen 192 to a screen 193. The screen 193 is an example of the screen displayed in step S1811 illustrated in FIG. 18.

In the screen 193, an operation key 193a corresponding to the registered course name is displayed as a list of registered course names. An operation of the operation key 193a in the screen 193 causes the screen 193 to transition to a screen 194. The screen 194 is an example of the screen displayed in step S1815 illustrated in FIG. 18.

In the screen 194, display fields 194a and 194b and an operation key 194c are displayed. In the display field 194a, a questionnaire name corresponding to the course name is displayed. The screen 194 indicates that the questionnaire name corresponding to the course name “Math 1” is “Math 1_Degree_of Understanding”. In the display field 194b, the lecture No. is displayed. The screen 194 indicates that the first and second lectures of the course assigned the course name “Math 1” have been performed.

In the screen 194, the number of submission materials is displayed in association with the lecture No. displayed in the display field 194b. The number of submission materials indicates the number of file IDs stored in the submission material information storage unit 266. The screen 194 indicates that there are 46 submission materials for the first lecture of the course assigned the course name “Math 1”. The screen 194 indicates that there is no submission materials for the second lecture of the course assigned the course name “Math 1”.

In response to an operation of the operation key 194c in the screen 194, a lecture No. is added in the display field 194b.

In response to selection of the lecture No. displayed in the display field 194b in the screen 194, the screen 194 transitions to a screen 195. The screen 195 is an example of the screen displayed in step S1821 illustrated in FIG. 18.

There are 46 submission materials for the Lecture No. “1st Lecture”. Thus, in the screen 195, document data of the distribution material, information representing the QR code, and submission materials are displayed as the list of lecture content. In the example of the screen 195, the document data of the distribution material is displayed as a thumbnail image 195c of the document data of the distribution material.

In the screen 195, an operation key 195a for instructing generation of the QR code is displayed as information indicating the QR code and an operation key 195b for instructing downloading of the submission material is displayed as the submission material.

In response to selection of the lecture No. “2nd Lecture” in the screen 194, the operation key 195a and the thumbnail image 195c of the distribution material are displayed in the screen 195 since there is no submission material.

The screens 194 and 195 are examples of the screens displayed after settings of the submission destination are finished and submission of the submission material from a student is accepted.

When the operation key 193a is operated for the first time, the screen 193 transitions to a screen 194A. A display field 194b′ of the screen 194A indicates that the corresponding lecture is “1st Lecture” of the course assigned the course name “Math 1” and that the number of submission materials is 0. That is, it is indicated that no submission material is submitted for this lecture.

In the screen 194, the document data of the distribution material may be uploaded and registered in the submission setting app 240-1 in association with the classification of the submission destination.

In response to selection of the lecture No. displayed in the display field 194b′ in the screen 194A, the screen 194A transitions to a screen 195A.

In the screen 195A, the operation key 195b may be displayed to be unselectable since the number of submission materials is 0. If the operation key 195b is operated, a message indicating that there is no submission materials to be downloaded may be displayed.

An operation of the operation key 195a in the screen 195A causes the screen 195A to transition to a screen 196.

In response to selection of the operation key 195a in the screen 195, the screen 195 transitions to the screen 196. The screen 196 is an example of the screen displayed in step S1823 illustrated in FIG. 18.

In the screen 196, the generated QR code 21 is displayed. The QR code 21 includes a URL for displaying the questionnaire assigned the questionnaire name “Math1_Degree_of_Understanding” and information for identifying the folder “/Math1/01” serving as the submission destination of a submission material. Part “/Math1” of the folder corresponds to the “course name” of the classification of the submission destination set in the introduction setting information, and part “/01” of the folder corresponds to “lecture No.” of the classification of the submission destination set in the introduction setting information.

In response to an operation of an operation key 196b in the screen 196, the image data of the QR code 21 displayed in the screen 196 is downloaded and is given to the document data of the distribution material.

In the present embodiment, a printed material resulting from printing the document data given the QR code 21 thus generated serves as the distribution material 20. As described above, the QR code 21 is merely an example of a code. For example, a code of another type such as a one-dimensional code may be used.

In the present embodiment, in response to the operation of the operation key 195b in the screen 195, a submission material group 197 stored in the submission material information storage unit 266 is downloaded.

As described above, in the present embodiment, the teacher's terminal 300 is caused by the submission setting app 240-1 to input the storage destination of the submission material when the QR code 21 is generated.

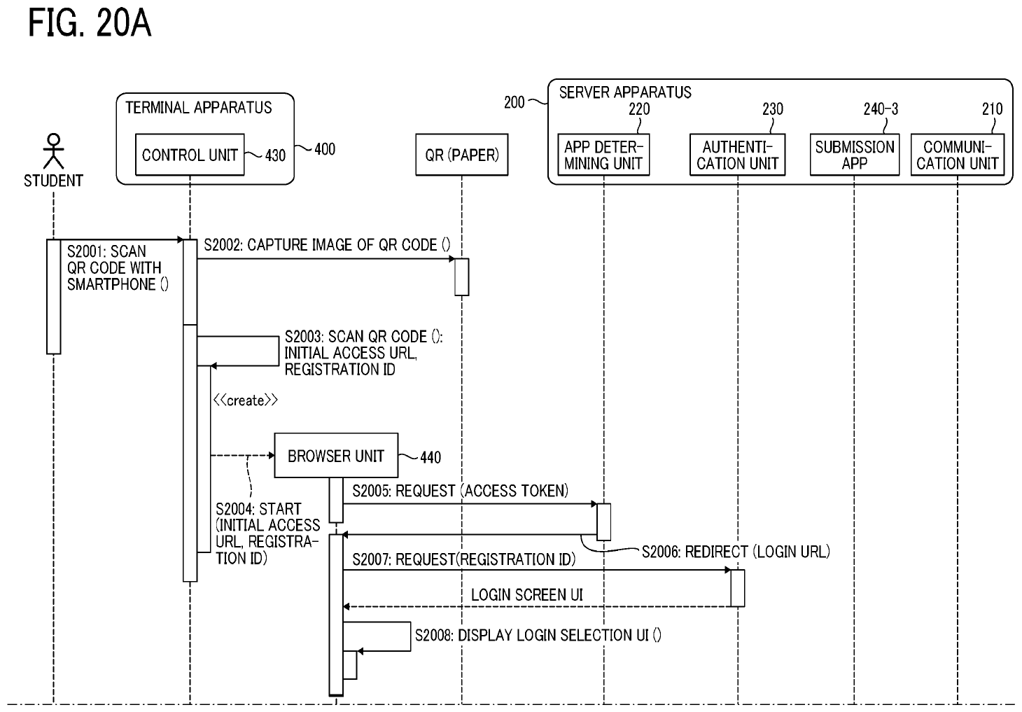

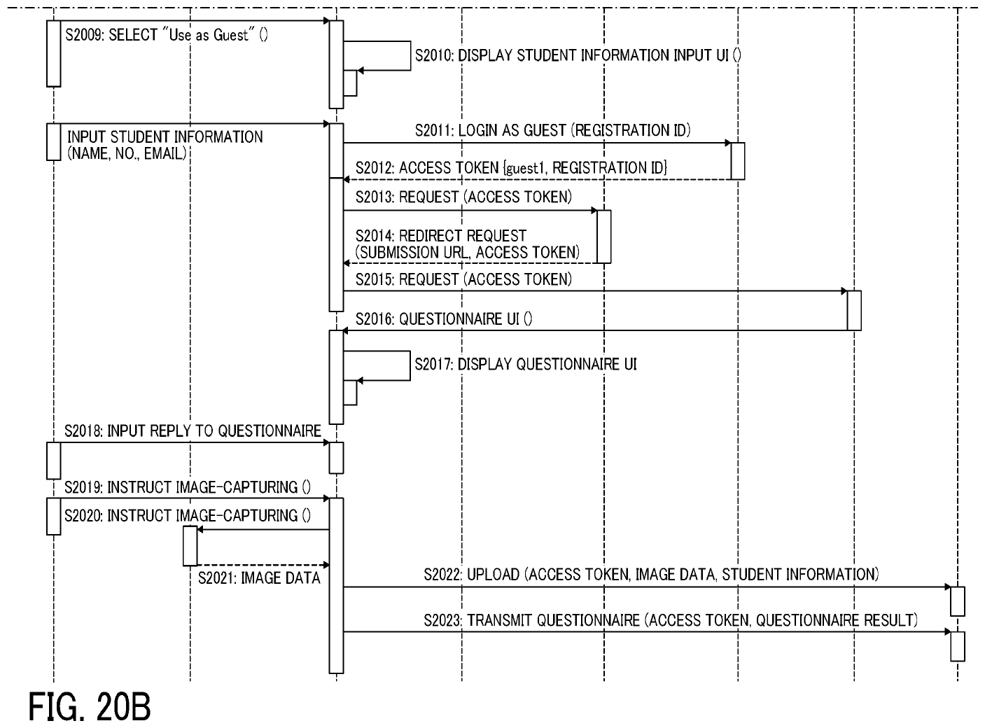

An operation of the student's terminal 400 of the information processing system 100 according to the present embodiment will be described next. FIG. 20 is a third sequence diagram illustrating an operation of the information processing system according to the first embodiment. FIG. 20 illustrates an operation performed when a student scans the QR code 21 printed on the distribution material 20 with the student's terminal 400 to use the submission app 240-3.

In the information processing system 100 according to the present embodiment, the student's terminal 400 accepts a scan instruction to scan a QR code from the student (step S2001). In response to the scan instruction, the control unit 430 instructs the image-capturing unit 460 to capture an image of the QR code. The image-capturing unit 460 causes the image-capturing apparatus to capture an image of the QR code (step S2002). In response to detection of an approach of the student's terminal 400 to the QR code, the student's terminal 400 may automatically activate the image-capturing apparatus to capture an image of the QR code.

The control unit 430 of the student's terminal 400 acquires the registration ID “Tag_SendM101” and the initial access URL (step S2003). In the case where the QR code is generated according to the method 5 described above, the registration ID to be acquired is “Tag_Send”.

The control unit 430 of the student's terminal 400 starts the browser unit 440 (step S2004). In response to the start, the browser unit 440 gives an access token to and automatically transmits a Hypertext Transfer Protocol (HTTP) request to the app determining unit 220 of the server apparatus 200 corresponding to the initial access URL (step S2005).

The access token according to the present embodiment includes the registration ID “Tag_QR01” acquired from the QR code and the user ID.

In the server apparatus 200, the app determining unit 220 requests the student's terminal 400 to redirect the request to a login screen in order to perform user authentication (step S2006).

In response to this redirect request, the browser unit 440 of the student's terminal 400 requests the authentication unit 230 of the server apparatus 200 to provide a URL of the login screen and acquires the login screen (step S2007).

The browser unit 340 causes a selection screen to be displayed which allows for selection of either the method of inputting account information to use the information processing system 100 or the method of using the information processing system 100 as a guest (step S2008). The browser unit 340 controls the display based on the login method set in the introduction setting information and the guest information input settings.

The browser unit 440 of the student's terminal 400 accepts selection of the method of using the information processing system 100 as a guest (step S2009), and causes a student information input screen to be displayed (step S2010). The student information according to the present embodiment includes the name, the student ID number, and the email address, for example.

The browser unit 440 of the student's terminal 400 accepts input of the student information, and transmits a guest login request to the authentication unit 230 of the server apparatus 200 (step S2011).

The authentication unit 230 of the server apparatus 200 creates user information in which the value of the item “user ID” is set to, for example, “guest1”, creates an access token for use in accessing this user information, and transmits the access token to the browser unit 440 (step S2012). The access token includes the registration ID that serves as an argument of the guest login request. The access token is stored in the browser unit 440.

The browser unit 440 transmits a connection request to connect to the app determining unit 220 along with the access token (step S2013).

The app determining unit 220 makes a redirect request to redirect the connection request to the submission app 240-3 that implements the service associated with the registration ID included in the access token (step S2014).

Specifically, the app determining unit 220 refers to the registration information storage unit 261 and identifies the app ID “AP_SendM101” corresponding to the registration ID “Tag_SendM101”. The app determining unit 220 then acquires a URL including the submission destination, associated with the app ID “AP_SendM101” representing the submission app 240-3 in the app information storage unit 262.

In response to the redirect request from the app determining unit 220, the browser unit 440 transmits the connection request along with the access token to the submission app 240-3 (step S2015).

In response to the connection request, the submission app 240-3 transmits, to the student's terminal 400, a URL of an user interface (UI) screen for displaying the questionnaire (step S2016).

Specifically, the submission app 240-3 identifies the submission destination ID (/Math1/01) from the URL indicating the submission app 240-3 and refers to the submission material information storage unit 266 (FIG. 9). If the file ID of the questionnaire is associated with the identified submission destination ID in the submission material information storage unit 266, the submission app 240-3 acquires questionnaire information that has been registered as the questionnaire in the setting operation illustrated in FIG. 14 and that corresponds to the file ID in the questionnaire information storage unit 265 (FIG. 10). The submission app 240-3 then transmits the information along with the URL of the UI screen for displaying the questionnaire (questionnaire U1) to the student's terminal 400.

In the case where the QR code is generated in accordance with the method 5, the QR code includes the submission destination ID. Thus, the browser unit 440 transmits the submission destination ID acquired from the QR code to the submission app 240-3 in step S2015.

In response to receipt of this URL, the browser unit 440 of the student's terminal 400 causes a questionnaire screen in which the questionnaire has been registered in the setting operation illustrated in FIG. 14 to be displayed (step S2017). The browser unit 440 of the student's terminal 400 accepts input of a reply to the questionnaire (step S2018).

The browser unit 440 of the student's terminal 400 also accepts an instruction to capture an image of the distribution material 20 including the reply (step S2019), and transmits, to the control unit 430, an image-capturing instruction to capture an image of the filled-in distribution material 20 (step S2020). The control unit 430 of the student's terminal 400 supplies the browser unit 440 with image data of the image which the image-capturing unit 460 has caused the image-capturing apparatus to capture in response to the image-capturing instruction from the control unit 430 (step S2021).

The browser unit 440 of the student's terminal 400 transmits, to the communication unit 210 of the server apparatus 200, the image data serving as the submission material, the access token including the user ID, and the student information (step S2022). The browser unit 440 of the student's terminal 400 then transmits, to the communication unit 210 of the server apparatus 200, the reply data representing the questionnaire result and the access token including the user ID (step S2023). The image data and the questionnaire result are stored, in association with the user ID included in the access token, as the submission material in the submission destination (indicated by the classification of the submission destination set in FIG. 18) specified by the QR code 21.

The URL of the communication unit 210 is the same as the URL associated with the app ID “AP_SendM101” in the app information storage unit 262. The image data and the reply data representing the questionnaire result are stored in the submission destination in association with the user ID included in the access token with reference to this URL.

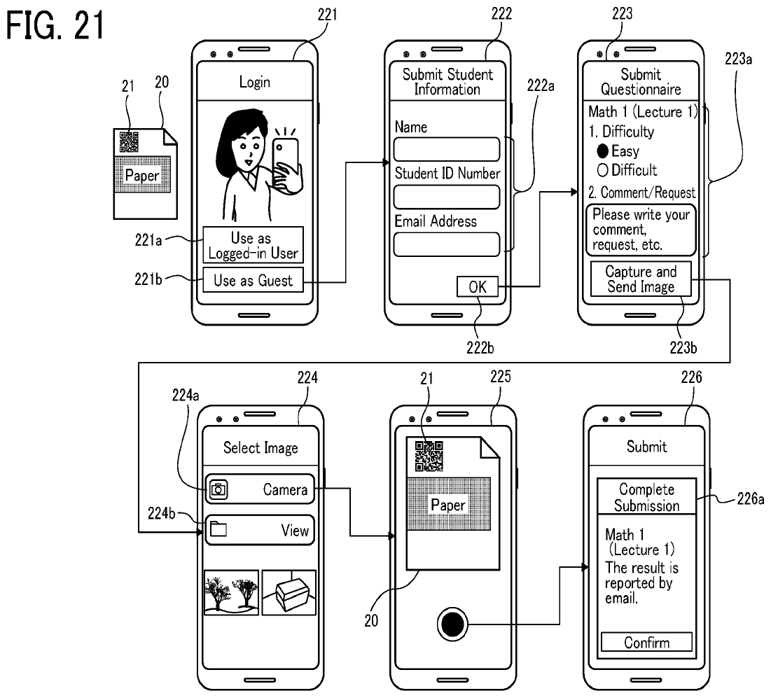

Transition of the screen on the student's terminal 400 in the operation illustrated in FIG. 20 will be described next with reference to FIG. 21. FIG. 21 is a diagram illustrating transition of a screen on the student's terminal according to the first embodiment.

In response to the student's terminal 400 scanning the QR code 21 printed on the distribution material 20, a screen 221 is displayed.

The screen 221 is an example of the screen displayed in step S2008 illustrated in FIG. 20. In the screen 221, an operation key 221a for selecting the method of logging in to use the information processing system 100 and an operation key 221b for selecting the method of using the information processing system 100 as a guest are displayed.

An operation of the operation key 221b in the screen 221 causes the screen 221 to transition to a screen 222. The screen 222 is an example of the screen displayed in step S2010 illustrated in FIG. 20.

In the screen 222, an entry field 222a and an operation key 222b are displayed. The entry field 222a is an entry field for inputting the student information. In the screen 222, the student information is input in the entry field 222a, and the operation key 222b is operated. This operation causes transition of the screen 222 to a screen 223.

The screen 223 is an example of the screen displayed in step S2017 illustrated in FIG. 20. In the screen 223, a questionnaire 223a assigned the questionnaire name “Math1_Degree_of_Understanding” and an operation key 223b for causing screen transition are displayed.

In the screen 223, an alternative of the reply to the questionnaire 223a is selected, and the operation key 223b is operated. This operation causes transition of the screen 223 to a screen 224.

In the screen 224, an operation region 224a for inputting an image-capturing instruction, and an operation region 224b for inputting an instruction to view the submission material submitted in the past are displayed. An operation of the operation region 224a in the screen 224 causes the screen 224 to transition to a screen 225.

The screen 225 is a screen for capturing an image. In the screen 225, an image of the distribution material 20 including the QR code 21 is captured. In response to an image of the distribution material 20 being captured in the screen 225, the screen 225 transitions to a screen 226.

In the screen 226, a display field 226a is displayed. In the display field 226a, a message indicating that the questionnaire result and the image data of the image of the distribution material 20 including the reply are stored as the submission material in the submission destination identified by the QR code 21 is displayed.

As described above, in the present embodiment, information indicating items to be input by the terminal apparatus 400 that has scanned the QR code 21 is included in the QR code 21. Thus, according to the present embodiment, the questionnaire result is automatically stored in the submission destination when the image data of the distribution material 20 including the answer is submitted.

The description has been given in the present embodiment that the questionnaire result is stored in the storage destination indicated by the QR code 21 along with the image data of the distribution material 20 including the answer. However, the configuration is not limited to this one.

In the present embodiment, the questionnaire result alone may be stored in the storage destination indicated by the QR code.

In this case, the questionnaire is displayed in response to the terminal apparatus 400 scanning the QR code 21, and the questionnaire result is stored in the storage destination specified by the QR code 21 in response to acceptance of a questionnaire result transmission instruction. Thus, in the present embodiment, the questionnaire result can be stored in the specified storage destination by just causing the terminal apparatus 400 to scan the QR code. Consequently, the time for collecting the questionnaire result is successfully saved.

An example of applying the information processing system 100 to education has been described in the embodiment above. However, the information processing system 100 may be applied to a field other than education.

In the present embodiment, the information processing system 100 may be applied to any situation in which, for example, a questionnaire result and image data are collected.

Specifically, for example, a QR code including a URL of a questionnaire screen and information indicating a storage destination of a questionnaire result and image data may be presented in a store such as a restaurant.

In this case, for example, a customer of the restaurant scans the QR code presented in the store with a terminal apparatus of the customer, replies to the questionnaire, and captures an image of a merchandise subjected to the questionnaire. Then, the questionnaire result and the image data of the merchandise are stored in the storage destination indicated by the QR code.

According to the present embodiment, the image data (or document data or the like) representing the target subjected to the questionnaire and the questionnaire result are successfully stored in the specified storage destination.

In the above example, the description has been given of an example in which the submission destination (submission destination ID) stored in the submission information storage unit 264 is uniquely identified, in response to an operation of the operation key 223b, by information (URL) associated with the app ID that is further associated with the registration ID. However, a plurality of submission destinations (submission destination IDs) may be associated with the app ID.

In such a case, for example, information indicating the submission destinations associated with the app ID (information on names or the like of folders corresponding to the submission destinations) is transmitted from the server apparatus 200 to the terminal apparatus 400 in response to an operation of the operation key 223b. This consequently allows the information indicating the submission destinations such as folders respectively corresponding to the plurality of submission destinations to be displayed on the screen of the terminal apparatus 400.

In response to a user (student) who submits a submission material selecting a specific submission destination (for example, an icon or name of a folder) from the information indicating the submission destinations such as the folders displayed on the screen of the terminal apparatus 400, the terminal apparatus 400 identifies the selected submission destination. The terminal apparatus 400 then transmits information on the selected submission destination (submission destination ID) to the server apparatus 200. The server apparatus 200 receives this information to be able to identify the submission destination ID. Note that which submission destination (folder) the user who submits the submission material is to select may be determined by a rule in advance or the user who receives the submission material may specify the submission destination by any type of communication such as verbal communication.

### Second Embodiment

A second embodiment will be described below with reference to the accompanying drawings. The present embodiment is different from the first embodiment in that QR codes are attached in advance to an educational material such as a textbook. In the description of the second embodiment below, differences from the first embodiment will be described. Components having substantially the same functional configurations as those of the first embodiment are assigned the same reference signs as those used in the description of the first embodiment to omit description thereof.

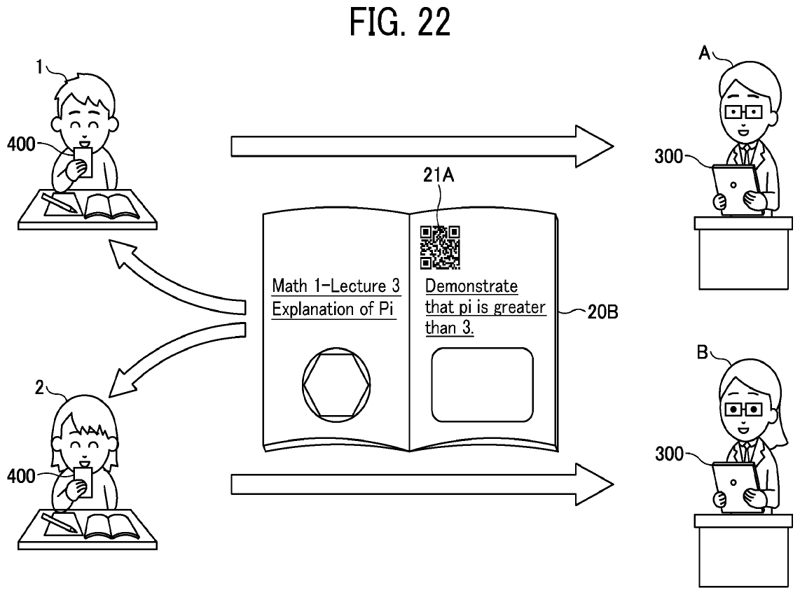

A situation in which an information processing system according to the second embodiment is used will be described below with reference to FIG. 22. FIG. 22 is a diagram illustrating an example of a situation in which the information processing system according to the second embodiment is used.

In the example illustrated in FIG. 22, an educational material 20B is used instead of the distribution material 20 distributed from a teacher to students. The educational material 20B is, for example, an educational material including a plurality of learning materials and a notebook. A QR code 21A is given to each of the plurality of learning materials in advance. The QR code 21A is merely an example of a code and may be a code of another type such as a one-dimensional code.

Each of the plurality of learning materials is, for example, an educational material used in a single lecture. Thus, the educational material 20B includes as many learning materials as the number of lectures to be conducted using the educational material 20B and the QR codes 21A for the respective learning materials.

In the present embodiment, the QR code 21A given to each learning material is used to associate information indicating content that is written in the educational material 20B with the submission destination associated with the QR code 21A.

The example illustrated in FIG. 22 presents the case where teachers A and B use the learning material “3rd Lecture of Math 1” of the educational material 20B in their lectures. The QR code 21A is given to the learning material “3rd Lecture of Math 1” of the educational material 20B.

In this case, the teacher A is to collect, as a submission material from a student 1 who has taken the lecture conducted by the teacher A, an image of the learning material “3rd Lecture of Math 1” in which the student 1 has written the answer.

The teacher B is also to collect, as a submission material from a student 2 who has taken the lecture conducted by the teacher B, an image of the learning material “3rd Lecture of Math 1” in which the student 2 has written the answer.

Accordingly, in the present embodiment, the QR code 21A including the registration ID for each learning material of the educational material 20B is given to the learning material. A list of teachers who have conducted lectures using this learning material is displayed on the student's terminal 400 in response to the student's terminal scanning the registration ID.

In the present embodiment, the image data representing the image of the learning material “3rd Lecture of Math 1” in which each student has written the answer is transferred from the student's terminal 400 to the submission destination corresponding to the teacher selected by the student. In the present embodiment, the image data representing the image of the learning material “3rd Lecture of Math 1” in which the student has written the answer is an example of a submission material.

In the present embodiment, through this process, even when a plurality of teachers use the same educational material 20B in different lectures, the submission material of each student who has taken one of the lectures is stored in a submission destination specified by the teacher who has conducted the lecture.

In the present embodiment, the QR code 21A is generated for and given to each learning material for which a submission material is to be submitted in the educational material 20B. In other words, in the present embodiment, as many the QR codes 21A as the number of lectures to be conducted using the educational material 20B are to be generated and to be given to the educational material 20B in advance. No QR code 21A may be given to the learning material for which no submission material is to be submitted.

In the present embodiment, a provider of a service using a server apparatus 200A may specify the tenant ID and generate the QR codes 21A, or the teachers who use the educational material 20B may generate the QR codes 21A.

Alternatively, in the present embodiment, an administrator of the educational material 20B at an educational institution may generate the QR codes 21A, or a creator of the educational material 20B may generate the QR codes 21A.

In the present embodiment, the QR codes 21A given to the educational material 20B may be used by a plurality of teachers (professors) who belong to the same educational institution. The QR codes 21A given to the educational material 20B may be used by teachers (professors) who belong to all the educational institutions (user environments) that own a tenant ID.

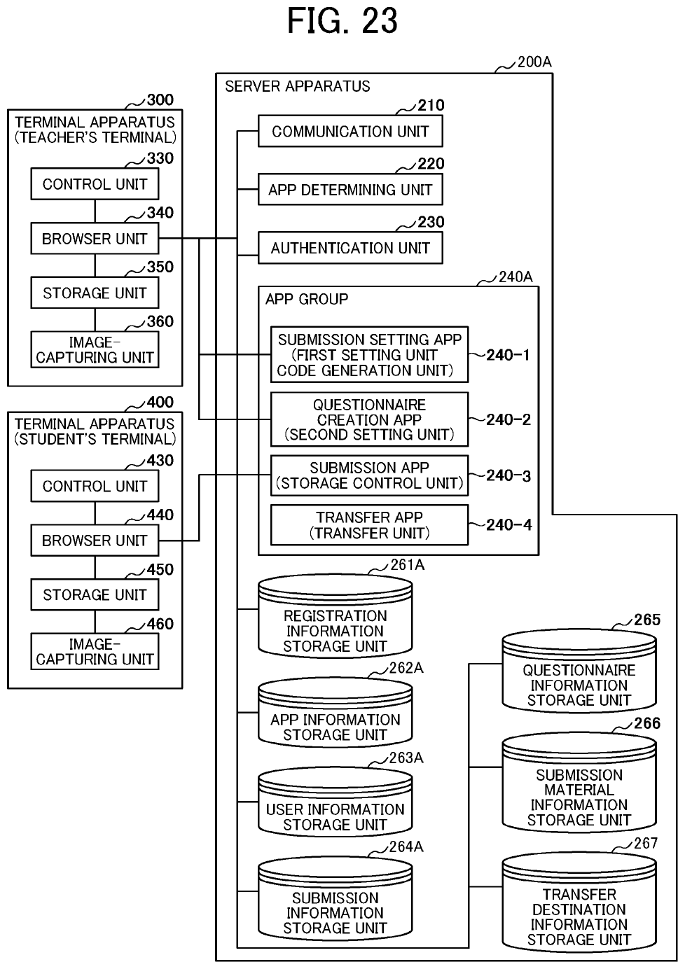

Functions of the server apparatus 200A, the terminal apparatus 300, and the terminal apparatus 400 of the information processing system 100 according to the present embodiment will be described next below with reference to FIG. 23. FIG. 23 is a block diagram illustrating an example of functional configurations of the server apparatus and the terminal apparatuses according to the second embodiment.

The server apparatus 200A according to the present embodiment includes an app group 240A. The server apparatus 200A according to the present embodiment includes a registration information storage unit 261A, an app information storage unit 262A, a user information storage unit 263A, a submission information storage unit 264A, and a transfer destination information storage unit 267.

The app group 240A according to the present embodiment includes, for example, the submission setting app 240-1, the questionnaire creation app 240-2, the submission app 240-3, and a transfer app 240-4.

The transfer app 240-4 according to the present embodiment is an application that implements a service for causing the student's terminal 400 to select the submission destination of the submission material that is transmitted from the student's terminal 400 in response to the student's terminal 400 scanning the QR code 21A and for identifying the submission app 240-3 corresponding to the submission destination selected in the student's terminal 400. The service implemented by the transfer app 240-4 may be referred to as a transfer service.

That is, the transfer app 240-4 is an example of a transfer unit configured to cause a storage destination of information transmitted from a second terminal apparatus in response to the second terminal scanning a code to be selected and that causes a storage control unit to store the information transmitted from the second terminal apparatus in the selected storage destination.

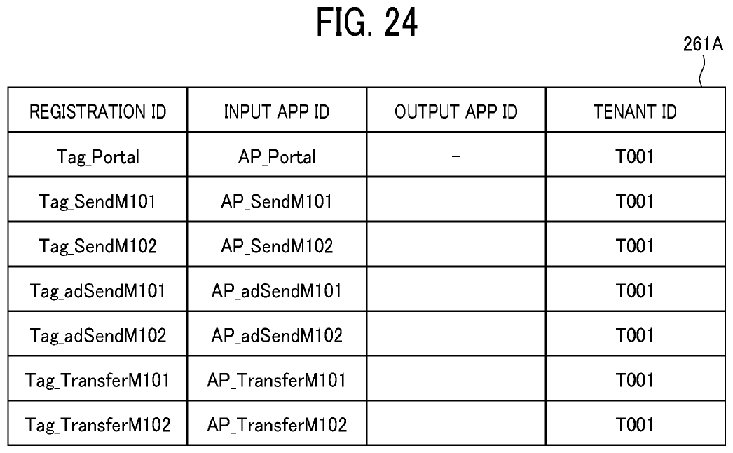

The registration information storage unit 261A, the app information storage unit 262A, the user information storage unit 263A, the submission information storage unit 264A, and the transfer destination information storage unit 267 of the server apparatus 200A will be described next with reference to FIGS. 24 to 28, respectively.

FIG. 24 is a diagram illustrating an example of the registration information storage unit according to the second embodiment. In the registration information storage unit 261A according to the present embodiment, registration IDs “Tag_adSendM101” and “Tag_adSendM102” are added to the registration information stored in the registration information storage unit 261 according to the first embodiment.

Each of the registration IDs “Tag_adSendM101” and “Tag_adSendM102” are associated with input app IDs “AP_adSendM101” and “AP_adSendM102”, respectively.

The registration information storage unit 261A also includes registration IDs “Tag_TransferM101” and “Tag_TransferM102”. The registration IDs “Tag_TransferM101” and “Tag_TransferM102” are associated with input app IDs “AP_TransferM101” and “AP_TransferM102”, respectively.

The transfer service according to the present embodiment is implemented by at least transfer apps respectively identified by app IDs “AP_TransferM101” and “AP_TransferM102”.

In the registration information storage unit 261A according to the present embodiment, a registration ID “Tag_TransferM10X” is added for each QR code 21A given to the corresponding learning material (lecture No.) included in the educational material 20B.

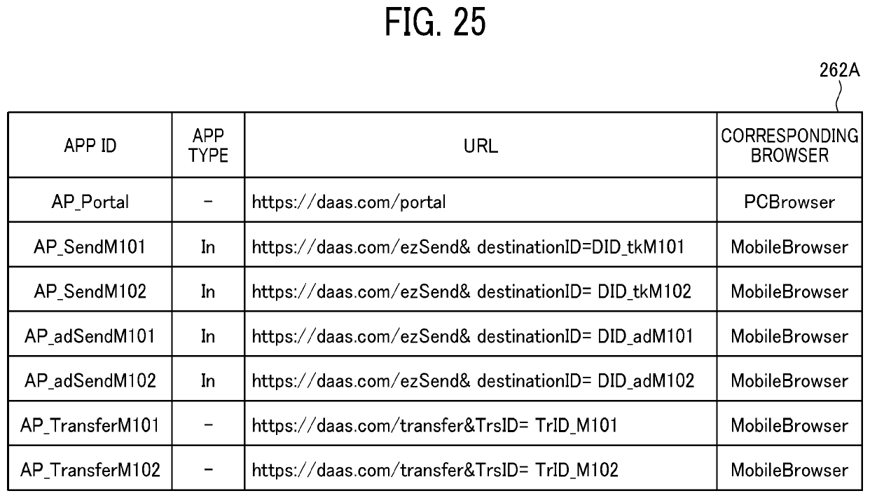

FIG. 25 is a diagram illustrating an example of the app information storage unit according to the second embodiment. The app information storage unit 262A illustrated in FIG. 25 additionally includes app information including app IDs associated with the respective registration IDs added to the registration information storage unit 261A.

Specifically, in the app information storage unit 262A, for example, app information including the app ID “AP_adSendM101” is added. The URL of the application identified by this app ID is “https://daas.com/ezSend&destinationID=DID_adM101”, and “destinationlD” is identification information for identifying a folder serving as the submission destination in which information is to be stored by the submission app 240-3.

In the app information storage unit 262A, app information including the app ID “AP_TransferM101” is added. The URL of the application identified by this app ID is “https://daas.com/transfer&TrsID=TrID_M101”, and “TrsID” is identification information for identifying a folder serving as the submission destination in which information transferred by the transfer app 240-4 is to be stored.

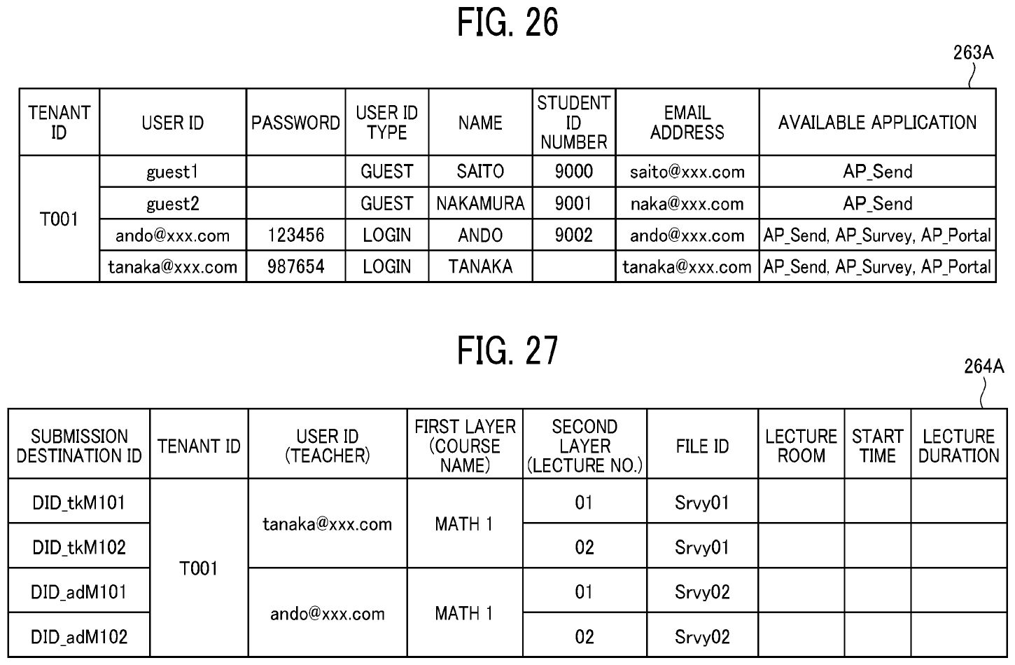

FIG. 26 is a diagram illustrating an example of the user information storage unit according to the second embodiment. In the user information storage unit 263A according to the present embodiment illustrated in FIG. 26, the user identified by the user ID “ando@xxx.com” is also permitted to use applications identified by the app IDs “AP_Survey” and “AP_Portal”.

FIG. 27 is a diagram illustrating an example of the submission information storage unit according to the second embodiment. The submission information storage unit 264A according to the present embodiment illustrated in FIG. 27 includes information items such as a submission destination ID, a tenant ID, a user ID, a first layer (course name), a second layer (lecture No.), a file ID, a lecture room, a start time, a lecture duration.

The values of the items “first layer (course name)” and “second layer (lecture No.)” are referred to when the name of a folder serving as the submission destination corresponding to the submission destination ID is generated.

Specifically, the name of the folder serving as the submission destination corresponding to the submission destination ID is generated to be “tenant ID/user ID/first layer/second layer”.

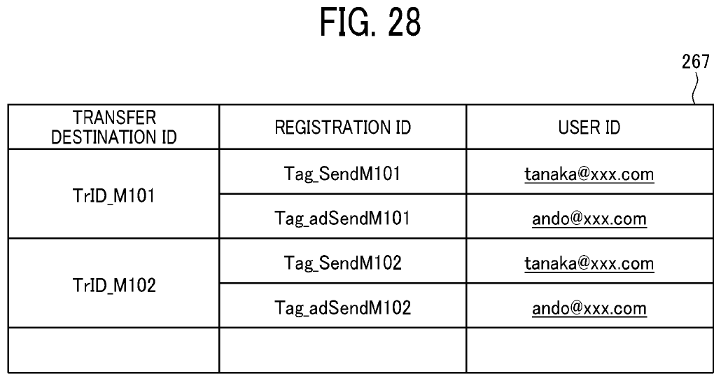

FIG. 28 is a diagram illustrating an example of the transfer destination information storage unit according to the second embodiment. The transfer destination information storage unit 267 illustrated in FIG. 28 includes information items such as a transfer destination ID, a registration ID, and a user ID.

The value of the item “transfer destination ID” is associated with the registration ID embedded in the QR code 21A given to each learning material of the educational material 20B. That is, the value of the item “transfer destination ID” is identification information for identifying the transmission destination of content written for each learning material (lecture No.) of the educational material 20B on which the QR code 21A is provided.

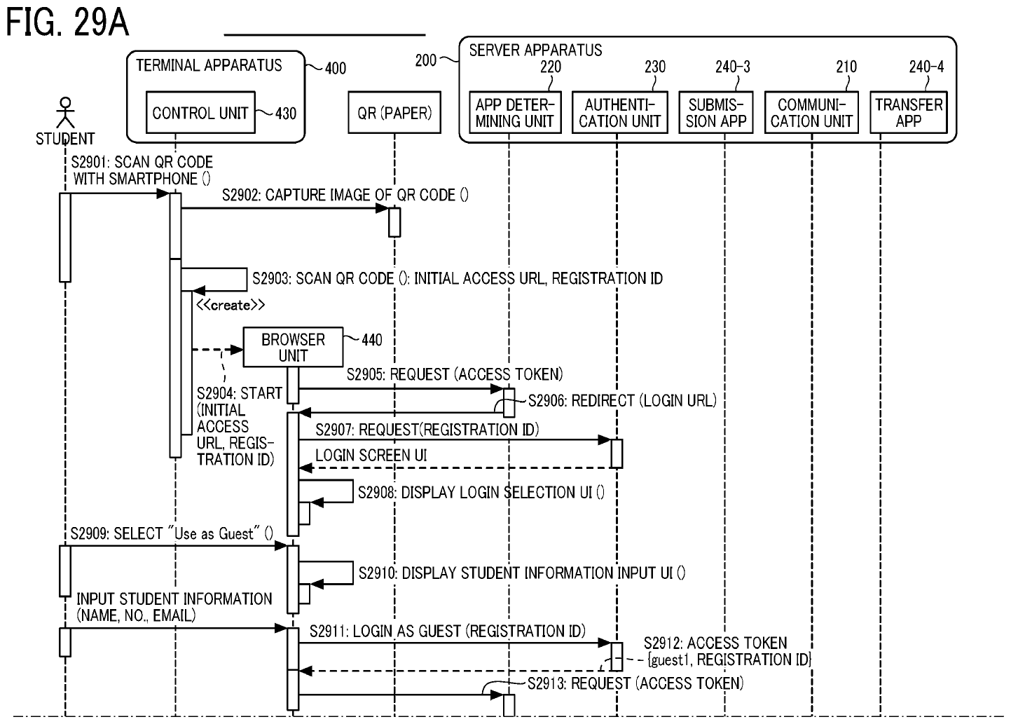

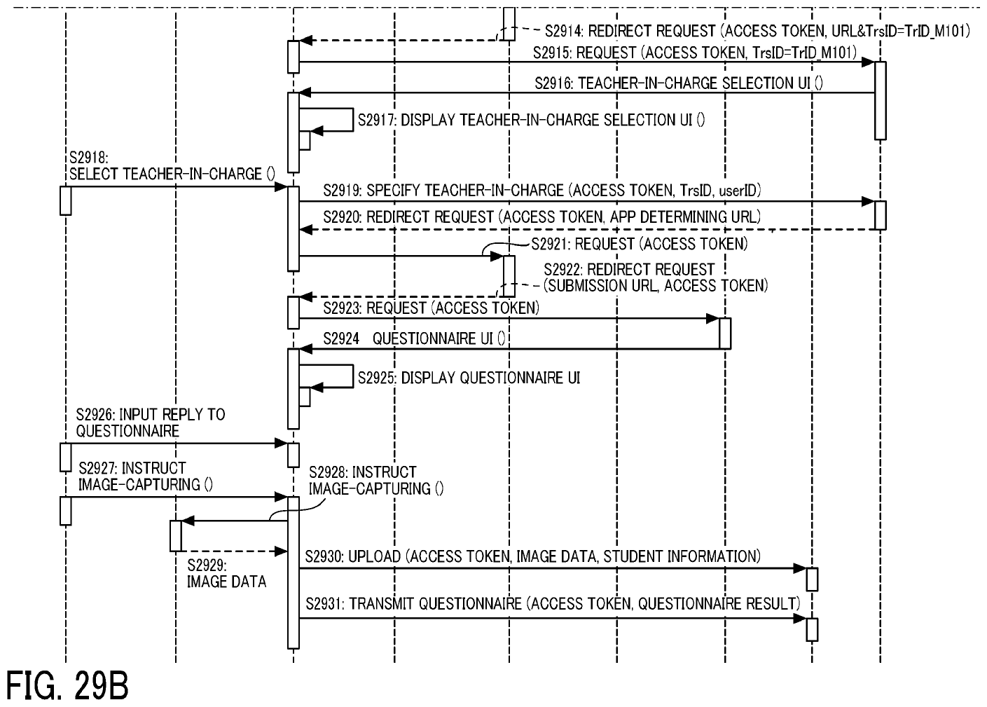

An operation of the information processing system according to the present embodiment will be described next with reference to FIG. 29. FIG. 29 is a sequence diagram illustrating an operation of the information processing system according to the second embodiment.

The student's terminal 400 according to the present embodiment receives a QR code scan instruction from a student (step S2901). The control unit 430 instructs the image-capturing unit 460 to capture an image of the QR code. The image-capturing unit 460 causes the image-capturing apparatus to capture an image of the QR code (step S2902).

The control unit 430 of the student's terminal 400 acquires the registration ID and the initial access URL (step S2903).

In the present embodiment, the QR code subjected to image-capturing is one of the QR codes 21A given to the educational material 20B. In the following description of FIG. 29, it is assumed that the registration ID “Tag_TransferM101” is acquired from the QR code 21A.

Since processing of steps S2904 to S2912 of FIG. 29 is substantially the same as the processing of steps S2004 to S2012 of FIG. 20 except that the registration ID is replaced with “Tag_TransferM101”, description thereof is omitted.

The access token transmitted from the authentication unit 230 of the server apparatus 200A to the browser unit 440 in step S2912 includes the registration ID “Tag_TransferM101” which is an argument of the guest login request. The access token is stored in the browser unit 440.

The browser unit 440 transmits a connection request to connect to the app determining unit 220 along with the access token (step S2913). The access token transmitted at this time includes the registration ID “Tag_TransferM101”.

The app determining unit 220 makes a redirect request to redirect the connection request to the transfer app 240-4 that implements the service associated with the registration ID included in the access token (step S2914).

The redirect request includes the registration ID “Tag_TransferM101”, the URL of the transfer destination associated with the app ID “AP_TransferM101” corresponding to the registration ID “Tag_TransferM101”, and the transfer destination ID.

In response to the redirect request from the app determining unit 220, the browser unit 440 transmits the connection request to the transfer app 240-4 indicated by the app ID “AP_TransferM101” (step S2915).

The connection request includes the access token and the transfer destination ID “TrID_M101” indicating the transfer destination corresponding to the app ID “AP_TransferM101”.

In response to the connection request, the transfer app 240-4 refers to the transfer destination information storage unit 267 to acquire the registration ID and the user ID that are associated with the transfer destination ID “TrID_M101”, and transmits, to the student's terminal 400, a URL of a selection screen including a list of users (teachers) associated with the user ID (step S2916).

In response to receipt of this URL, the browser unit 440 causes a teacher selection screen to be displayed (step S2917). Since the user IDs associated with the transfer destination ID “TrID_M101” are “tanaka@xxx.com” and “ando@xxx.com”, a list of names respectively associated with these user IDs are displayed as the teacher selection screen.

The browser unit 440 accepts selection of a teacher in the teacher selection screen (step S2918) and transmits, to the transfer app 240-4, the user ID corresponding to the selected teacher and the transfer destination ID along with the access token (step S2919).

The transfer app 240-4 receives the user ID and the transfer destination ID, overwrites the access token with the registration ID associated with the user ID in the transfer destination information storage unit 267, and makes a redirect request to redirect the request to the app determining unit 220 (step S2920).

Specifically, for example, if the selected user ID is “tanaka@xxx.com”, the registration ID of the access token is overwritten to “Tag_SendM101”.

In the present embodiment, through this process, the transfer destination of the image data of an image captured by the terminal apparatus 400 is specified to be the storage destination indicated by the URL associated with the registration ID “Tag_SendM101”.

In response to the redirect request, the browser unit 440 transmits a connection request to the app determining unit 220 (step S2921).

Since processing from step S2921 to step S2931 is substantially the same as the processing from step S2013 to step S2023 illustrated in FIG. 20, description thereof is omitted.

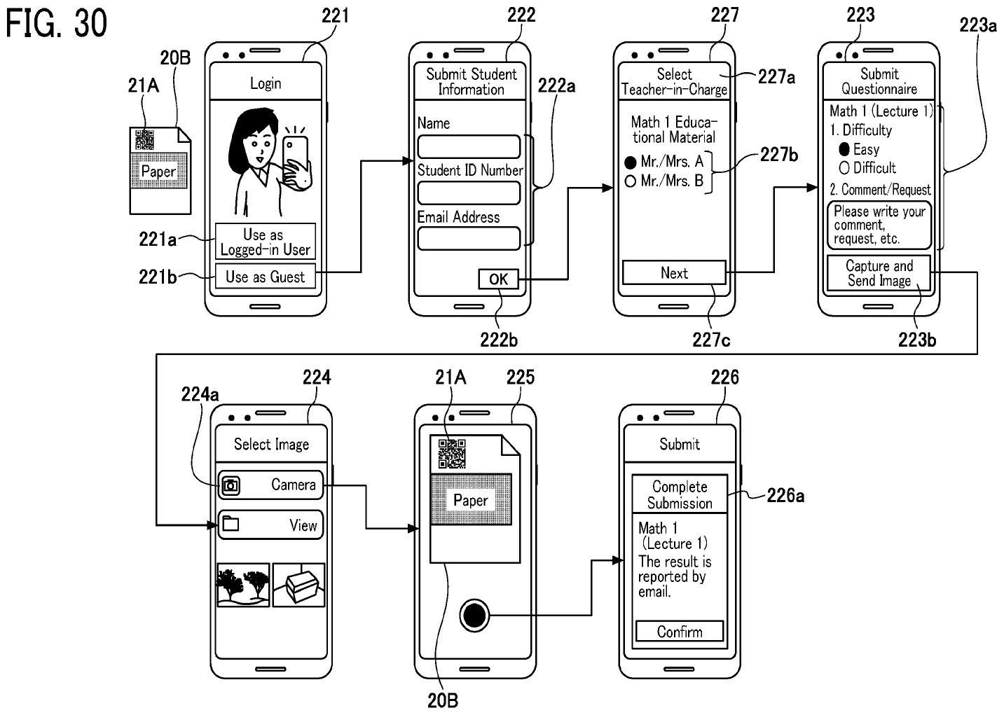

Transition of the screen on the student's terminal 400 according to the present embodiment will be described next with reference to FIG. 30. FIG. 30 is a diagram illustrating transition of the screen on the student's terminal according to the second embodiment.

In the present embodiment, the screen 222 is displayed in step S2910. The student information is input in the entry field 222a, and the operation key 222b is operated. This operation causes transition of the screen 222 to a screen 227.

The screen 227 is the teacher selection screen displayed by the browser unit 440 in step S2917 illustrated in FIG. 29.

The screen 227 includes a display field 227a, a selection field 227b, and an operation key 227c. In the display field 227a, the name or the like of the educational material 20B is displayed. The name of the educational material 20B may be embedded in, for example, the QR code 21A.

In the selection field 227b, a list of names of users indicated by the user IDs associated in the transfer destination information storage unit 267 with the registration ID included in the QR code 21A scanned by the student's terminal 400 and selection keys are displayed.

In the selection field 227b of the screen 227, the list of names of users are displayed such that either the teacher A (Mr./Mrs. A) or the teacher B (Mr./Mrs. B) is selectable. In the screen 227, an entry field for directly inputting a keyword (password or watchword) that is recognized in common by the students and the teacher-in-charge may be displayed in addition to the list of names of teachers. It is sufficient that the names of users displayed in the list in the selection field 227b correspond to names of users who receive submission materials. Thus, teachers in charge are merely an example.

In the screen 227, a teacher is selected, and the operation key 227c is operated. This operation causes transition of the screen 227 to the screen 223.

In the present embodiment, the operation key 223b is operated in the screen 223, and an image of the educational material 20B is captured in the screen 225. Then, the questionnaire result and image data of the educational material 20B in which the answer has been written are stored, as a submission material, in the transfer destination corresponding to the teacher selected in the screen 227.

As described above, according to the present embodiment, even if a plurality of teachers conduct lectures using the same educational material given the same QR code, submission materials for each of the lectures can be stored in a submission destination corresponding to the teacher who has conducted the lecture.

In the above example, the description has been given of an example in which in response to selection of a name of a user (teacher) in the selection field 227b, the submission destination (submission destination ID) stored in the submission information storage unit 264 is uniquely identified by information (URL) associated with the app ID that is further associated with the registration ID corresponding to the user. A plurality of submission destinations (submission destination IDs) may be associated with the app ID.

In such a case, for example, information indicating the submission destinations associated with the app ID (information such as names of folders corresponding to the submission destinations) are transmitted from the server apparatus 200A to the terminal apparatus 400 after the name of the user (teacher) is selected. This consequently allows information indicating submission destinations such as folders respectively corresponding to the plurality of submission destinations to be displayed on the screen of the terminal apparatus 400.

In response to a user (student) who submits a submission material selecting a specific submission destination (for example, an icon or name of a folder) from the information indicating the submission destinations such as the folders displayed on the screen of the terminal apparatus 400, the terminal apparatus 400 identifies the selected submission destination. The terminal apparatus 400 then transmits information on the selected submission destination (submission destination ID) to the server apparatus 200A. The server apparatus 200A receives this information to be able to identify the submission destination ID. Note that which submission destination (folder) the user who submits the submission material is to select may be determined by a rule in advance or the user who receives the submission material may specify the submission destination by any type of communication such as verbal communication.

In the embodiment described above, the paper educational material is used. However, the educational material is not limited to the paper material. The educational material (including an answer sheet and a distribution material) need not be a paper material, and may be distributed as electronic data and be displayed on an electronic device owned by each user.

In the embodiment described above, a material used mainly at an educational institution such as an answer sheet or an educational material is treated as an example of a submission material. However, the submission material is not limited to this one. Examples of the submission material include a meeting material, an explanatory material, and a distribution document, for example.

In the embodiment described above, the description has been given of an example in which a code such as a QR code is given to a distribution material or a submission material such as an educational material. However, the code and the distribution material or submission material such as an educational material need not be integrated together.

The code may be given to another medium different from the submission material. Specifically, for example, the code corresponding to the distribution material or the submission material such as an educational material may be displayed as an image in the screen that is displayed on the display used by the teacher for explanation. In such a case, the student first scans the code displayed as an image and then captures an image of the submission material to be submitted.

In the case where the code is given to another medium different from the submission material, the user who submits the material may prepare the submission material. Specifically, for example, the submission material may be image data obtained by the submitting user (student) capturing an image of a subject or image data obtained by the submitting user (student) capturing an image of content written on paper prepared by the user.

In this manner, even if a distributed material or educational material not given any code has already been distributed or there is no distribution material or educational material, the submission destination can be flexibly changed in accordance with the lecture style. Examples of the lecture style include a style in which students take a lecture online at remote locations as well as a style in which students take a lecture at a classroom.

In the embodiment described above, the description has been given of an example in which a teacher is a person who receives a submission material (submission destination) and a student is a person who submits a submission material (submitter). However, the relationship between the submission destination and the submitter is not limited to a relationship between a teacher and a student.

The example in which the relationship between the submission destination and the submitter is the relationship between the teacher and the student is merely an example. The present disclosure is applicable to any use situations in which there are a user who receives some kind of submission material and a user who submits the submission material. Specifically, examples of the use situations to which the present disclosure is applicable include a seminar or class held by an instructor and students and a meeting or explanatory meeting held by a speaker and an audience. As described above, such use situations may be offline or online.

As described above, the information processing system according to at least one embodiment enables at least part of information associated with a service to be flexibly set in accordance with a use situation in which a user uses the service.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

The group of apparatuses described in each of the embodiments merely indicates one of a plurality of computing environments for implementing the embodiment disclosed herein.

In one embodiment, the server apparatus 200 (200A) includes a plurality of computing devices such as server clusters. The plurality of computing devices are configured to communicate with each other via a communication link of any type including a network, shared memory, or the like and perform the processes disclosed herein. Likewise, the terminal apparatus can include a plurality of computing devices configured to communicate with each other. The server apparatus and the terminal apparatus can be configured to share the disclosed processing steps in various combinations.

While the present disclosure has been described based on each embodiment above, the present disclosure is not limited by the requirements described in the above embodiment. In this regard, the present disclosure can be modified within a scope not departing from the gist thereof, and can be appropriately implemented according to an application style thereof

1. An information processing system comprising:
an information processing apparatus;
a first terminal apparatus configured to request generation of a code including identification information for identifying a service provided by the information processing apparatus; and
a second terminal apparatus configured to scan the code,
wherein the information processing apparatus includes
circuitry configured to
set, based on information received from the first terminal apparatus, information indicating a first input item to be displayed on the first terminal apparatus in association with the service, and
set, based on information received from the first terminal apparatus, information indicating a second input item that is different from the first input item and that is to be displayed on the second terminal apparatus, in association with the service, prior to the generation of the code.

2. The information processing system according to claim 1, wherein the first terminal apparatus is configured to accept, as a value of the first input item, a value indicating a storage destination at which information transmitted from the second terminal apparatus is to be stored.

3. The information processing system according to claim 1, wherein the second terminal apparatus is configured to display, as the second input item, a question included in a questionnaire in response to scanning the code and accept a reply to the question as a value of the second input item.

4. The information processing system according to claim 1, wherein the circuitry of the information processing apparatus is configured to generate, in response to the first terminal apparatus requesting the generation of the code, the code including the identification information for identifying the service, a value input for the first input item, and information for displaying a questionnaire including the second input item.

5. The information processing system according to claim 3,
wherein the second terminal apparatus is configured to transmit, to the information processing apparatus, a questionnaire result including the value of the second input item, and
wherein the circuitry of the information processing apparatus is configured to store information transmitted from the second terminal apparatus in a storage destination indicated by a value input for the first input item, the information transmitted from the second terminal apparatus including the questionnaire result.

6. The information processing system according to claim 3,
wherein the second terminal apparatus is configured to transmit, to the information processing apparatus, a questionnaire result including the value of the second input item, and
wherein the circuitry of the information processing apparatus is configured to store information transmitted from the second terminal apparatus at a selected storage destination, the information transmitted from the second terminal apparatus including the questionnaire result.

7. The information processing system according to claim 5, wherein the information transmitted from the second terminal apparatus includes image data representing an image of a printed material on which the code is printed, the image being captured with an image-capturing apparatus included in the second terminal apparatus.

8. An information processing apparatus communicable with a plurality of terminal apparatuses including a first terminal apparatus and a second terminal apparatus, the information processing apparatus comprising
circuitry configured to
set information indicating a first input item to be displayed on the first terminal apparatus in association with a service provided by the information processing apparatus, the first terminal being configured to request generation of a code including identification information for identifying the service, and
set, in response to the second terminal apparatus scanning the code, information indicating a second input item that is different from the first input item and that is to be displayed on the second terminal apparatus in association with the service, prior to the generation of the code.

9. An information processing method performed by an information processing apparatus communicable with a plurality of terminal apparatuses including a first terminal apparatus and a second terminal apparatus, the information processing method comprising:
setting information indicating a first input item to be displayed on the first terminal apparatus in association with a service provided by the information processing apparatus, the first terminal apparatus being configured to request generation of a code including identification information for identifying the service; and
setting, in response to the second terminal apparatus scanning the code, information indicating a second input item that is different from the first input item and that is to be displayed on the second terminal apparatus in association with the service, prior to the generation of the code.
